(19) United States
(12) Patent Application Publication
(10) Pub. No.: US 2009/0313225 A1
(43) Pub. Date: Dec. 17, 2009

(54) INFORMATION MANAGEMENT OF RIGHTS CLEARANCE SYSTEM AND METHOD FOR USING THE SAME

(76) Inventor: Walter O'Neal Nordlinger, Los Angeles, CA (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 12/298,573

(22) PCT Filed: May 9, 2006
(86) PCT No.: PCT/US06/18033

§ 371 Date: Dec. 18, 2008

(51) Int. Cl. G06F 17/30

(52) U.S. Cl. 707/3; 707/104.1; 707/E17.044; 707/9; 707/E17.008; 707/E17.01

(57) ABSTRACT

The current invention provides an interactive system or platform suitable for performing a research project by individuals associated with a research company and a client company seeking the research. The interactive system provides a centralized electronic exchange for managing the research project and enhancing interaction between individuals carrying out the research and individuals associated with the client. Further, the current invention provides a method for using the interactive system which improves the research process.

### BACKGROUND AND FIELD OF THE INVENTION

The current invention was developed as a tool for the entertainment industry to coordinate the process of obtaining rights and permissions for the use of logos, music, video clips and other components commonly incorporated into the production of movies, television programs and other media. The current invention is also applicable to other industries requiring file sharing and coordination amongst team members that may be remote from one another. For example, the current invention will also find uses within the medical insurance industry and well as the intelligence field. In particular, the current invention is suitable for any research and clearance project requiring data analysis and comments by remote users having varying degrees of responsibility for the project.

To aid in the understanding of the current invention, this disclosure will primarily focus on the platform as it is adapted for use within the entertainment industry and the method of using that platform to obtain rights and permissions in the production of a movie. The process of obtaining rights and permissions for logos, trademarks, trade dress, an individual's name and likeness and prominent buildings for a movie production accounts for a significant portion of the costs associated with producing the movie. Most, if not all, film makers typically obtain an insurance policy known in the industry as an errors and omissions policy. This policy protects theater owners, film distributors, financiers and others associated with the movie from claims of infringement related to materials appearing within the film. Prior to issuing such insurance, the insurance companies require the performance of a due diligence study typically known as a search and clearance study to insure that all necessary rights and permissions have been obtained for the movie. Since damages for copyright infringement among other infringements of intellectual property can be very high, the insurance companies typically establish very stringent guidelines for this due diligence process.

Movie productions may take place over a wide range of areas and sets while encompassing a variety of subject matter. As a result, the rights and permissions process is typically contracted to a research and clearance company. Depending on the stage of the production, the research and clearance company typically issues one of three reports: a “research report”, a “clearance report” or a “research and clearance report.” Each name describes the nature of the report. Thus, the research report is designed to identify those portions of a script or production which may require permission for use prior to shooting the film. The clearance report subsequently verifies that each area requiring permission for use has been cleared by obtaining such permission or has been altered to remove the need for permission. The research and clearance report is a combination of the two prior mentioned reports.

Because the search and clearance process is a time consuming process these reports are necessarily updated from time to time to accommodate changing conditions in the script or location. Additionally, these reports must be reviewed and commented on by the various team members associated with the production of the film. For example, the film's producer and director will be required to provide information concerning the script and options for possible changes in the script in view of problems discovered during the research process by the research and clearance company. While e-mail and websites currently enhance the exchange of information between the parties, it would be beneficial if a centralized browser based platform were available to coordinate the exchange of information between the team members and to provide a mechanism for remotely discussing the search and clearance process.

The current invention provides such a platform and a method for using the platform thereby improving the search and clearance process by enhancing communication and accountability between team members.

### SUMMARY OF THE INVENTION

The current invention provides a platform comprising an interactive system wherein team members may be assigned differing levels of access while the system provides for aggregating data for use by the team members. The system establishes a hierarchy among the team members and enables the tracking and exchange of information between the team members. Additionally, the system provides a data base for the storage and exchange of documents and the tracking of the comments made by team members during analysis of the documents. The platform is suitable for use in a variety of fields including health care, the entertainment industry and any other field utilizing search and clearance procedures in order to manage risk.

In practicing the method of the current invention, a Platform Administrator utilizes the platform to provide access to ongoing projects for active clients. The Platform Administrator grants the client's administrator (Client Administrator) access to the platform and sets the permissions for the Client Administrator. These permissions determine the degree of access and rights granted to the Client Administrator. The Platform Administrator also selects and grants rights to at least one research and/or clearance company (RC Company) associated with the project to be carried out by the client. The RC Company preferably has an RC Administrator who is granted rights and permissions on the platform by the Platform Administrator.

Team members for the ongoing project may be added by both the Client Administrator and by the RC Administrator. Each of these administrators will determine the rights and permissions to be granted to the team members for their respective rolls in the research and clearance project.

In the practice of the current invention, necessary data is entered into the platform by both each administrator. Using the platform of the current invention, the RC Administrator enters data relevant to the current project. Additionally, the RC Administrator selects team members for the RC Company Team and grants each member access rights as necessary to the platform. Similarly, the Client Administrator uses the platform to review the progress of the RC Company and to provide feedback suitable for advancing the project. Additionally, the Client Administrator uses the platform to add team members associated with the Client Team including determining the rights for each team member.

The current invention provides an interactive system for coordinating a research project between at least two parties. The interactive system comprises a platform administrator module, a research and clearance module and a client module. Additionally, the interactive system provides a database suitable for storing data entered through the platform administrator module, the research and clearance module and the client module. The platform administrator module provides the platform administrator with the ability to add a project to the system, add a research entity to the system and add new clients to the system. Additionally, the platform administrator module allows the platform administrator to associate a project with a client entity and a research entity. Further, the platform administrator module provides data entry capabilities suitable for granting individuals associated with the research entity and the client entity access to the interactive system through their respective modules. The client and research and clearance modules also provide individuals, having the appropriate clearance, with the ability to grant access to the interactive system to additional individuals.

Each module forming part of the interactive system includes a login page and a home page. The homepage preferably depicts at least the number of active and inactive projects, active and inactive clients and the number of individuals logged into the system. Further, each homepage view comprises a navigation bar. Each navigation bar provides the user access to the interactive system through the assigned module. In the research and clearance module, the navigation bar provides the individual associated with the research entity with access to a report template suitable for building a report relating to the assigned project. The client module provides individuals associated with the client entity access to the report generated by the research entity.

Additionally, the client and research and clearance modules provide individuals associated with each module access to data relating to each individual associated with the project. This data allows members associated with each entity to have improved communication and cooperation during the performance of a project. Further, the client and research and clearance modules provide individuals associated with the project access to recent activity relating to the project and stored within the database.

The current invention also provides a method for conducting a research project. The method comprises the steps of: providing a computer based interactive system comprising:
a platform administrator module;
a research and clearance module;
a client module;
a database suitable for storing data entered through the platform administrator module, the research and clearance module and the client module;
a platform administrator accessing the interactive system using the platform administrator module;
the platform administrator adding a project to the system;
the platform administrator adding a research entity to the system;
the platform administrator adding a client entity to the system.

In the method of the current invention, the platform administrator accesses the interactive system through the platform administrator module using a web browser. Typically, access to the system will require entry of a username and password. Having gained access to the interactive system, the platform administrator will associate at least one individual with the research entity, granting that individual rights and permissions to access the interactive system. Additionally, the platform administrator will associate at least one individual with the client entity, granting that individual rights and permissions to access the interactive system.

In addition to providing access to the interactive system to individuals associated with each entity, the platform administrator will add a project to the system. If the project is not related to a current client entity, then the platform administrator will add a new client entity and individual associated with that entity. Further, the platform administrator will relate or associate the project with a research entity adding a new research entity and associated individual if necessary.

In the method of the current invention, the individuals associated with the client and research entities will carryout the research project by accessing their respective modules to gain access to the interactive system. Each module is typically accessed by providing a username and password on a login page to gain access to the homepage for the respective modules. Once access has been gained to the interactive system, the initial individuals assigned to the research entity and the client entity will use their respective modules to provide additional individuals with access to the interactive system. Each additional individual will be associated with their respective entity and will be granted rights to access the interactive system as determined by the initial individuals associated with each entity.

Further, in the method of the current invention, users or individuals associated with each entity will access the interactive system to view projects associated with their respective entities. If the individual is associated with a research entity, the individual will preferably use a report template provided by the research and clearance module to build a report suitable for indicating the progress of the research relating to the project. If the individual is associated with the client entity, they will preferably access the client module, review the report and provide feedback concerning the status of items listed on the report.

Additionally, individuals associated with each entity during performance of the project will add data to the report including text data and electronic files. For example, mpeg, jpegs, Adobe files may be added to the report by individuals associated with each entity.

Finally, individuals having access to the interactive system will interact with each other through links provided on the report and other components of each module. Additionally, direct contact between individuals is enhanced by the method of the current invention. The enhancement results from ready access to contact information through the interactive system stored during granting of individuals granted access to the interactive system. Preferably as each individual is added to the system, their contact information will be added to a database by the entering user. As work progresses on the project, individuals will access the database to obtain contact information for individuals assigned to the project and will use information such as an e-mail address to correspond with other project members.

### BRIEF DESCRIPTION OF THE FIGURES

FIGS. 1-20 are screen captures associated with the platform administrator module portion of the current invention.

FIGS. 21-29 are screen captures associated with the research and clearance module of the current invention.

FIGS. 30-50 are screen captures associated with the client module of the current invention.

FIGS. 51-61 are screen captures associated with the research and clearance module.

FIGS. 62-65 are screen captures associated with the client module.

FIGS. 66-90 are screen captures associated with the research and clearance module.

### DETAILED DISCLOSURE OF THE PREFERRED EMBODIMENT

The current invention provides a platform for performing clearance studies. In the preferred embodiment, the platform is a browser-based system operating in a secure environment. The secure environment may run as an extranet, an intranet or on the Internet. Regardless of the interconnection configuration for the platform, the platform preferably comprises at least three modules: a platform administrator module, a client module and a research and clearance module. The functions of each of the above referenced modules will be described in detail below. For the sake of conciseness an clarity, with regard to the accompanying FIGS., the following discussion utilizes the actual element name found in the FIGS. As opposed to identification numbers.

The platform administrator module provides overall control of the platform. The platform administrator uses this module as a gatekeeper function determining the rights and privileges of each individual accessing the platform. In the preferred embodiment, the platform is accessed through a computer using a conventional web browser. On start up, the platform presents a welcome page including at least a log on tab which in turn provides access to a log on page. In the preferred embodiment, the Platform Administrator Log On page requires a user name and a password to gain access to the full functionality of the platform.

The client module provides the client entities with access to the interactive system and their respective projects. The research and clearance module provides the research entities with access to the interactive system including projects assigned to the research entities and the tools necessary to prepare a report relating to each project assigned to the research entity. For the remainder of the disclosure, the description assumes that the research entity is a company selected to perform research and/or clearance study for a project. Additionally, the client entity is assumed to be a company desiring a research and/or clearance report relating to an ongoing project such as a moving production. Therefore, the terms “client” and RC company or research and clearance company will be used for the remainder of the disclosure of the preferred embodiment. Individuals associated with each entity will have differing roles as determined by the lead member or president for each company. Titles of the individuals associated with the client or RC company are not critical to the current invention and may be changed. Rather, the key considerations for individuals associated with each module are the rights and permissions granted to each individual.

Once logged on to the platform administration module, the user, i.e. the platform administrator, gains access to the home page which provides access to all the tools offered by the platform. In particular, the home page reflects the status of the platform including at least the following: the number logged in users; the number of active and inactive clients; and the number of active and inactive projects. Additionally, the home page acts as a port or entrance to the various components of the platform.

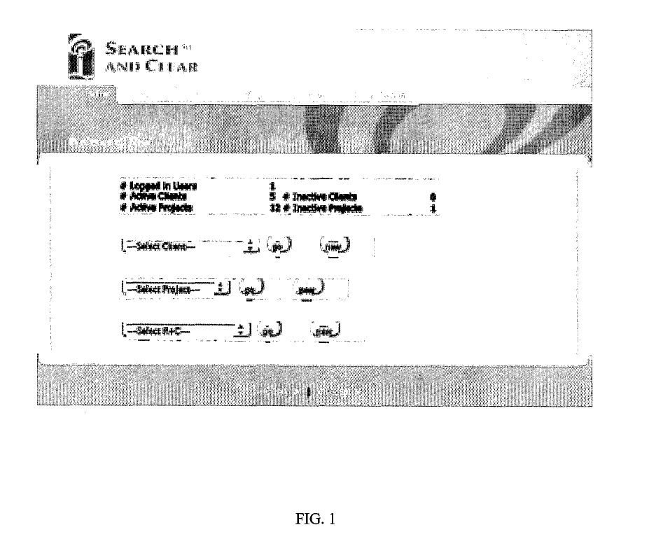

In particular, when logged in as a platform administrator, an individual has the ability to add new clients, add new projects and to determine the research and clearance company to be associated with the clients and projects. An example of one potential configuration for the homepage is depicted in FIG. 1. As shown in FIG. 1, drop down windows are provided for the clients, projects and research and clearance companies. Viewing of active or inactive clients can be selected by clicking on the drop down window and selecting the client. Alternatively, new clients may be added by clicking on the “new” button adjacent to the “select client” dropdown which activates the portion of the platform designed for entry of new clients.

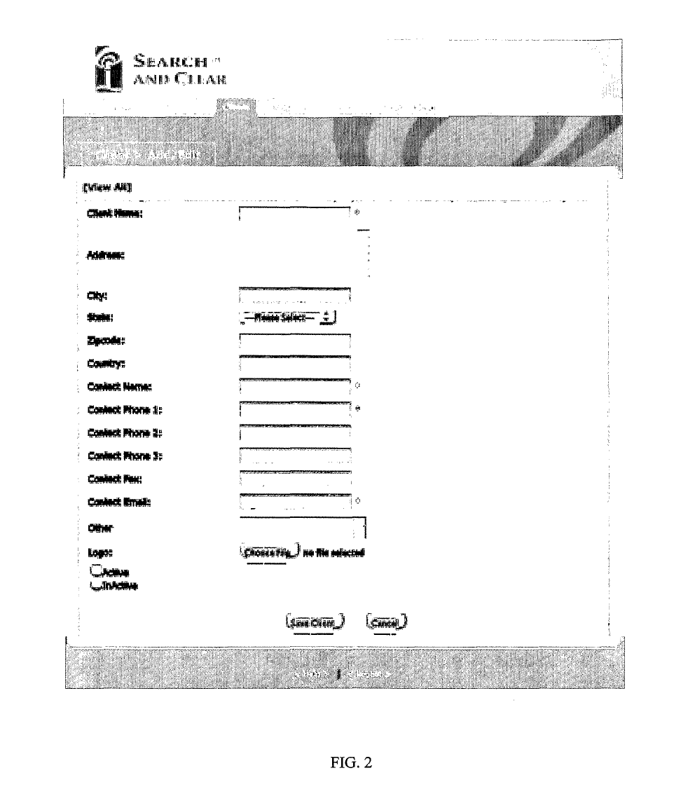

An example of a web page set up for entry of a new client is provided in FIG. 2. As depicted therein, information relative to the client is entered in the appropriate boxes. This information is subsequently stored by the platform in a suitable database. Client information entered in this manner is useful for coordination of the project as well as for billing purposes by the platform administrator.

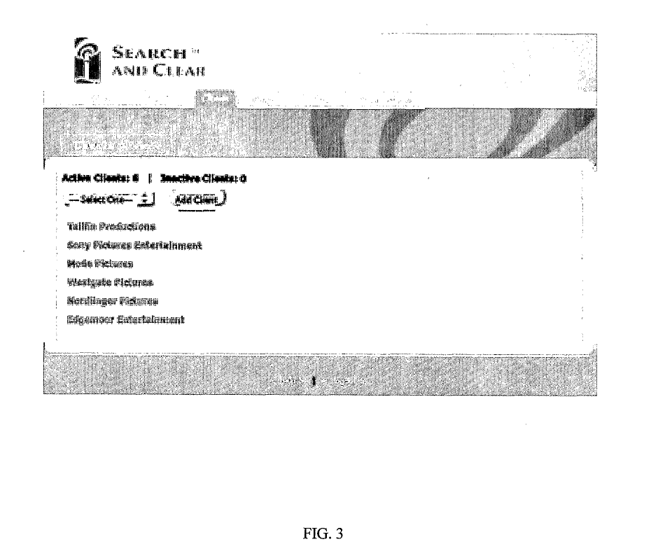

In the preferred embodiment, the viewing of client lists on the platform administrator module may be segmented between active and inactive clients. Thus, the preferred embodiment allows for the display of only active or inactive clients or the combination thereof as desired by the platform administrator. This feature permits verification of the active clients following the addition of a new client. Examples of web pages depicting the “active clients”, “inactive clients” and “view all clients” are provided in FIGS. 3-5.

As noted above, the platform homepage provides the ability to view and add new projects. Additionally, as shown in FIGS. 1-5, each web page preferably includes a top line banner providing direct access to the various components of the platform administrator module. For example, as shown in FIGS. 1-5, the top line banner includes links or tabs to the Home page, the Administrator page (Admin), Clients, Projects, Research and Clearance (R/C), and User's Administration (User Admin). Thus, the platform allows for easy movement between the various components of the platform administrator module.

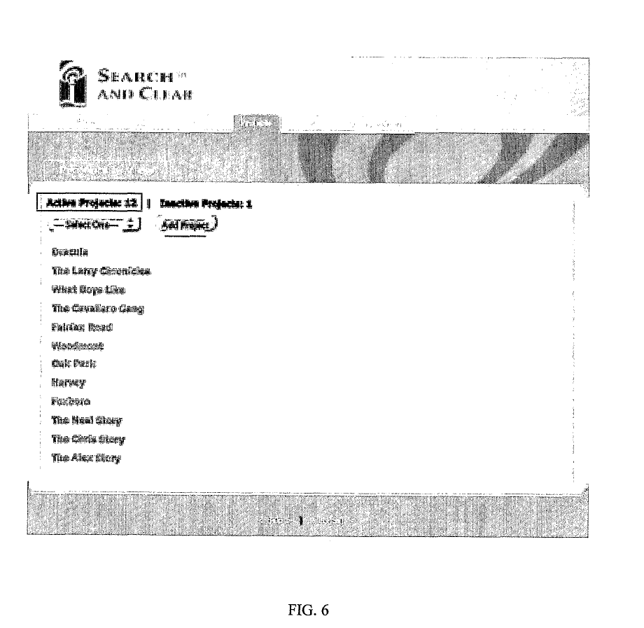

When accessed through either the homepage or the projects tab on the top line banner, the projects portion of the platform administrator module allows for viewing of the active and inactive projects as well as the addition of new projects to the platform administrator module. Further, when added through the platform administration module, each project becomes available to the other team members including the clients and the research and clearance companies providing services to the clients. An example of the projects view found or accessible through the platform is provided by FIG. 6. In this example, the active view has been selected and it displays twelve active projects. Preferably a drop down window is provided for selecting the view to be displayed.

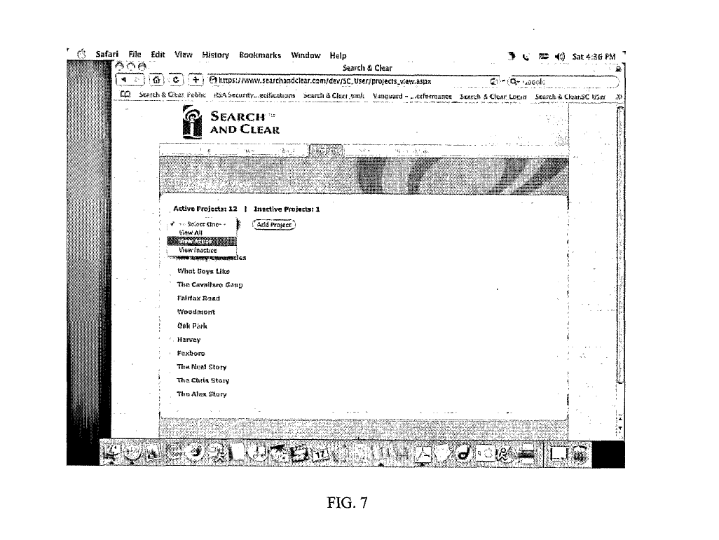

As indicated in FIG. 7, the projects view to be displayed may be “view all”, “view active”, or “view inactive.” Additionally, the Projects page provides a button or hot link allowing for the addition of a new project. In FIG. 7, the button is identified as “Add Project.”

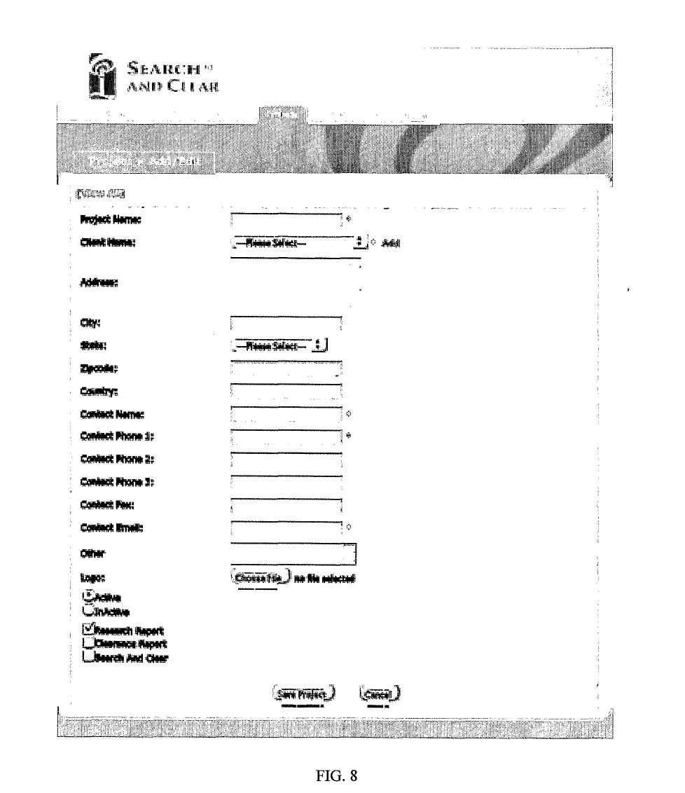

To add a project, the platform administrator clicks or selects the link entitled “Add Project.” The Project Add/Edit page depicted in FIG. 8 is one example of a preferred embodiment for adding a project to the platform administrator module for use and access by the clients and the research and clearance company. As shown in FIG. 8, this page provides entry boxes for information relevant to the project including the project name and the client name. In particular, mandatory boxes are preferably indicated by a star or other callout insignia. In the preferred embodiment, the box for the client name includes a drop down window or other suitable multi-listing device which enables pulling a current client name into the add project page. In the method of using the platform discussed below, the preferred method entails first entering the client name in the new client page such that the client name is available in the drop down window on the project page.

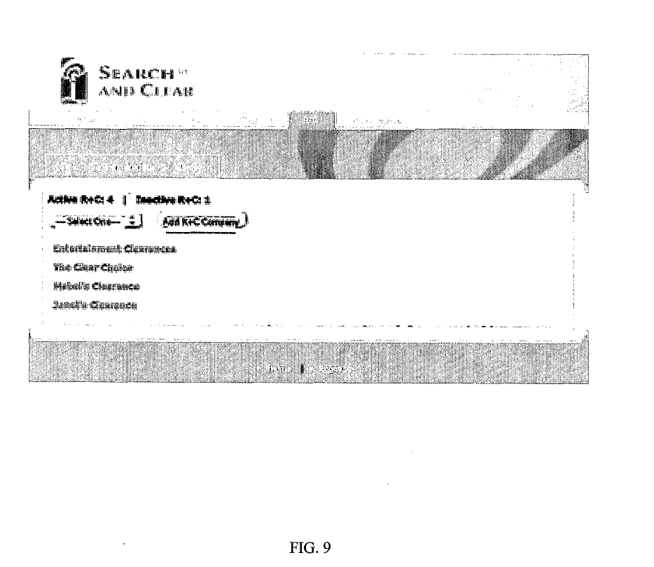

Another preferred component of the platform administrator module is the ability to identify, select and/or add research and clearance companies to be associated with the active projects. As previously indicated, access to the database of research and clearance companies stored within the platform is available either through the homepage by way of a drop down window or other multi-selection tool or through the top line banner which includes a tab labeled R/C. Either route will take the platform administrator to the R+C Companies view depicted in FIG. 9. The R+C Companies page is similar to the pages associated with the projects and the clients as this view depicts the number of active and inactive research and Clearance companies (RC companies) and also allows for viewing either only “active,” only “inactive” or a “view all” selection as made available through the drop down window.

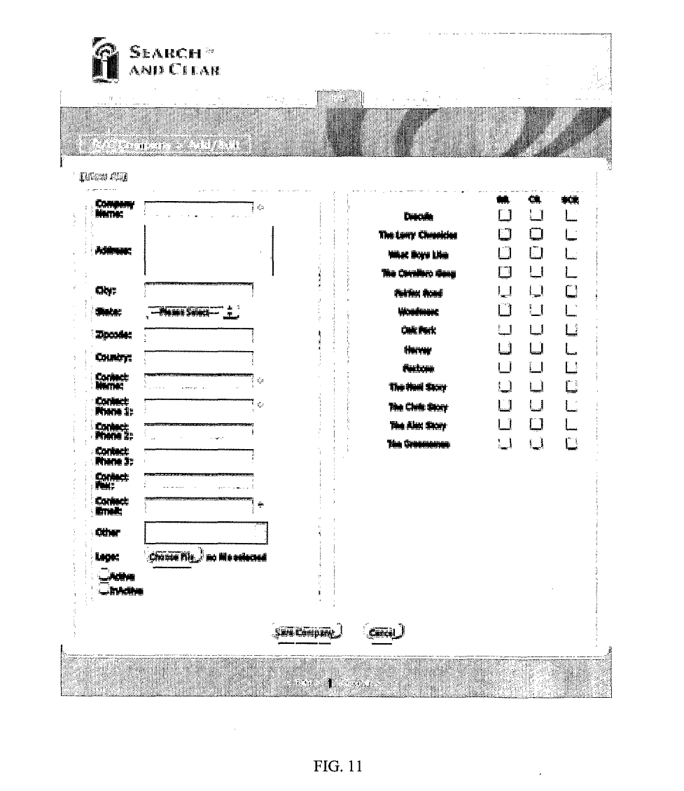

The RC component of the platform administrator module provides allows the platform administrator to associate an RC company with a project. Additionally, as noted above, if a client desires a RC company not currently installed or listed on the platform, a new RC company may be added by selecting the add R/C button. If a new RC company is added to the platform, a web page similar to that provided in FIG. 11 will provide the ability to enter the necessary data associated with that RC company.

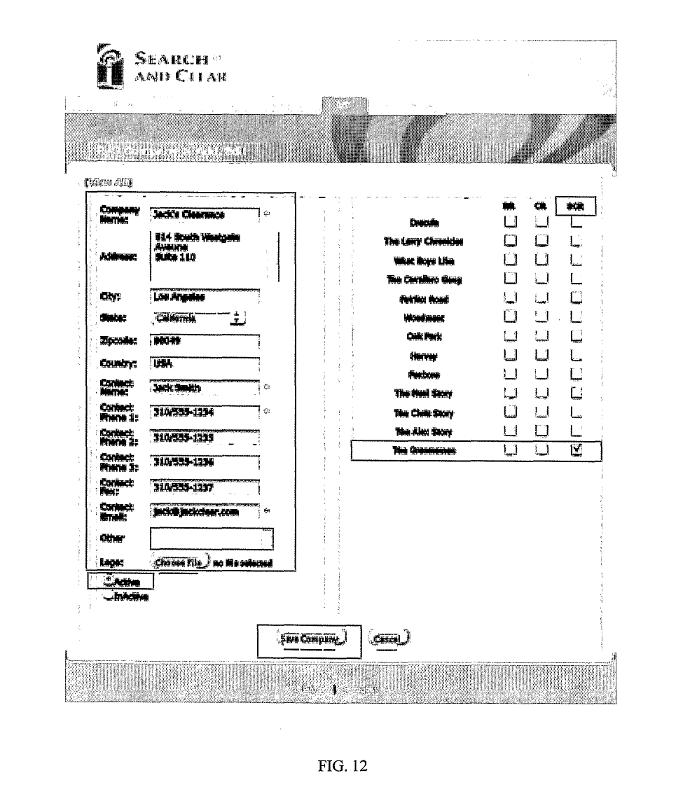

Additionally, as indicated in FIG. 11, the role of that RC company is indicated for the relevant project. As noted in the right hand column of the page depicted in FIG. 11, this role may entail the development of a research report identified by the RR column, a clearance report identified by the CR column or a search and clearance report identified by the SCR column. For each project in which the RC company is responsible, a check will appear in the relevant box related to the project and the type of report to be provided. For example, as depicted in FIG. 12, the new RC company Jack's Clearance has been added as an active RC company and it is been identified as providing a search and clearance report for the project entitled The Groomsmen.

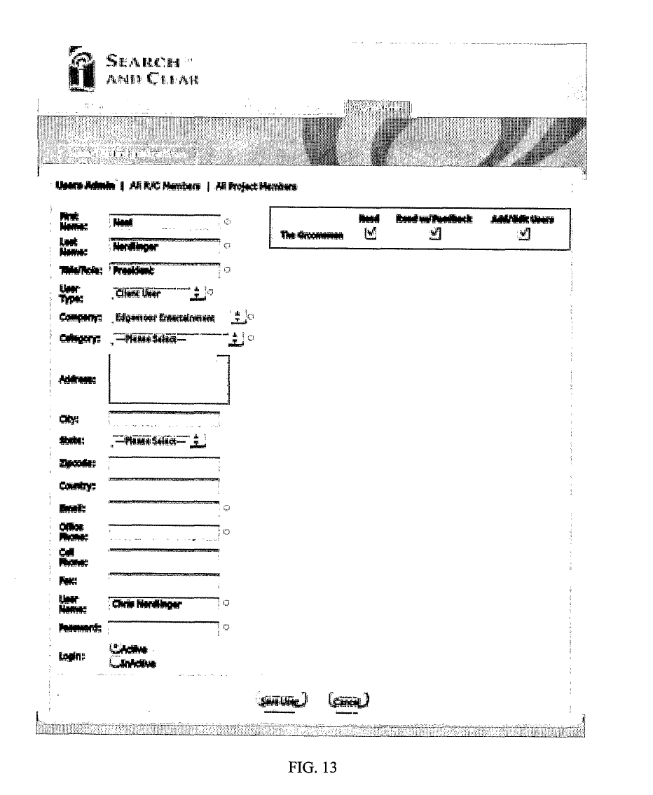

Since the purpose of the platform is to enable data analysis related to research and clearance projects, team members must be identified for the clients as well as the research and clearance companies. Entry of the team members for each project is enabled by the “Users Admin” button found on the top banner line. On accessing the “User Admin” button, the platform administrator module provides access to a web page suitable for permitting entry of a team member. An example of such a page is depicted in FIG. 13. As shown therein, essential boxes are starred or otherwise identified by a callout insignia. As shown in FIG. 13, the boxes provide for the entry of the team member's name, their title or role, identification of whether the team member is a client, user or a RC company team member, identification of the company with which the team member is associated and a category identification which may include a listing associated with that team member's role within the company or the role of the company itself. Boxes associated with the entry of the team member may be changed or added depending on the type of project being performed.

As the boxes are completed, the platform administrator module preferably associates the name of the individual and/or the client with data presently stored within the platform's database. For example, in FIG. 13 a team member identified as associated with the company Edgemoor Entertainment has been entered. Previously, Edgemoor Entertainment has been entered as a client company associated with the project entitled the Groomsmen. Following selection of the client company, Edgemoor Entertainment, during entry of the team member's data, the platform administrator module automatically associates this data with any ongoing projects and displays the projects on the right hand side of the user administrator window. As indicated in FIG. 13, the only associated project, The Groomsmen is provided with ethree potential check boxes. Selection of these boxes indicates the rights and permissions granted to the team member. In this instance, the team member Neal Nordlinger has been identified as the President of Edgemoor Entertainment. As such, the platform administrator has granted the President all potential rights and permissions by checking the boxes associated with “read,” “read with feedback,” and “add/edit users.” Thus, this particular team member will have the ability to read and to provide feed back on all reports submitted through the search and clear platform. Additionally, this team member will have the ability to add and/or edit additional client users. Following completion of the entry associated with this initial client user, the platform administrator may continue to enter additional members associated with this client user. However, by granting the initial client user the rights to add/edit users, further entry is not necessary as this client user will have the ability to add any additional team members in a similar manner.

In addition to entering team members drawn from the client, the platform administrator will preferably enter at least one team member drawn from the research and clearance company. The “User Admin” button also provides access to the portion of the platform administrator module suitable for entering team members drawn from the RC Company. The link for accessing project team members, i.e. client members, can be gained either through the “User Admin” tab or through the buttons labeled “all project members”. As is typical in a website design, there are multiple pathways to any particular portion of the module. In the preferred embodiment, R/C Members are accessed or viewed by selecting the “all R/C members” link and Client members of the project are accessed by selecting the “Project Team Members” link. In the preferred embodiment, the views depict all members associated with either the RC Company or the Client but not both at the same time.

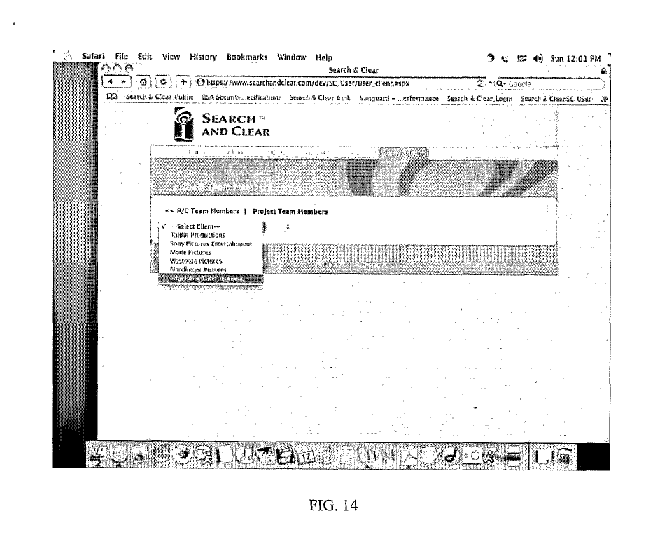

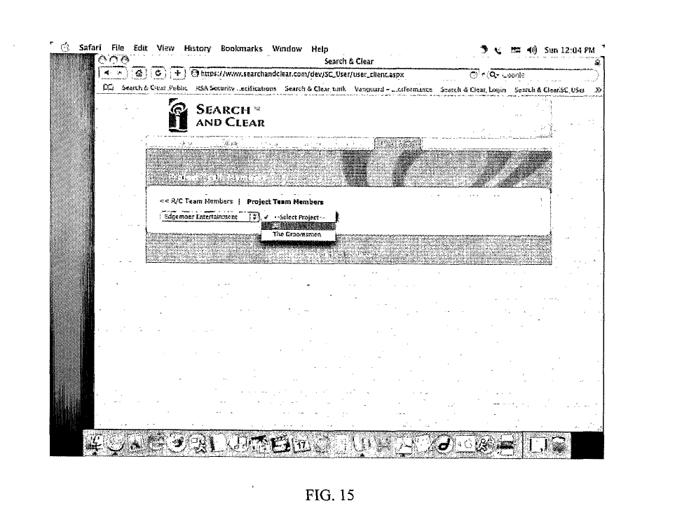

Once at the desired website, the client for the active project is selected as shown in FIG. 14 using a drop down window. Subsequently, project team members may be viewed either for all project team members associated with the client or based on individual projects as depicted in FIG. 15. Addition of team members selected from the applicable research and clearance company is carried out in a manner similar to the addition of team members for the client company.

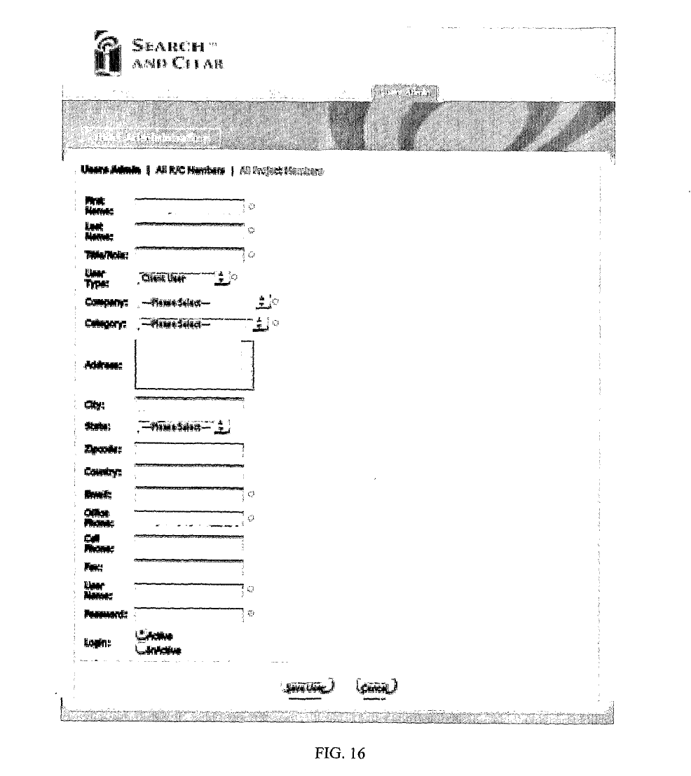

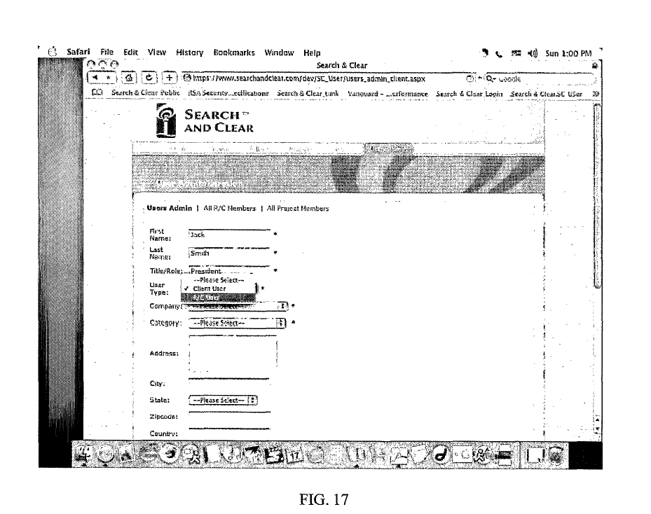

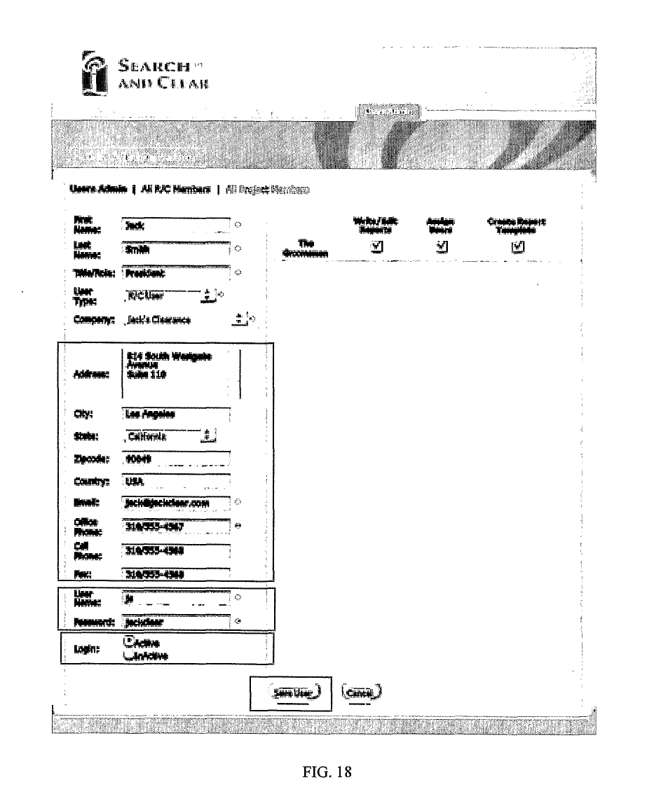

As depicted in FIG. 16, the data entry page for each team member contains boxes necessary to identify the team member, their role on the team as well as the name of the research and clearance-company and the category of the work to be performed. As depicted in FIG. 17, the role of the team member as a user is preferably identified by using a drop down window or other similar selection device suitable for identifying the team member as either a client user or an R/C user. Further, in a manner similar to that for selecting client users, the drop down window for identifying the company is preferably associated with data stored in the platform's database. Thus, as depicted in FIG. 18, selection of a company will automatically associate the company with the projects for which it is performing research and/or clearance duties. As depicted in FIG. 18, the company, Jack's Clearance, is associated with a single project entitled The Groomsmen. In this instance, the new team member, Jack Smith has been identified as the President and has been granted the rights and permissions suitable for writing and editing reports, assigning users and creating report templates. Following entry of this RC member, the platform administrator may continue to add additional RC members associated with Jack's Clearance or another RC company associated with the project. However, since this RC team member has been granted permissions and rights suitable for writing and editing reports assigning users and creating report templates, this team member may also add additional team members to the R/C user portion of the platform.

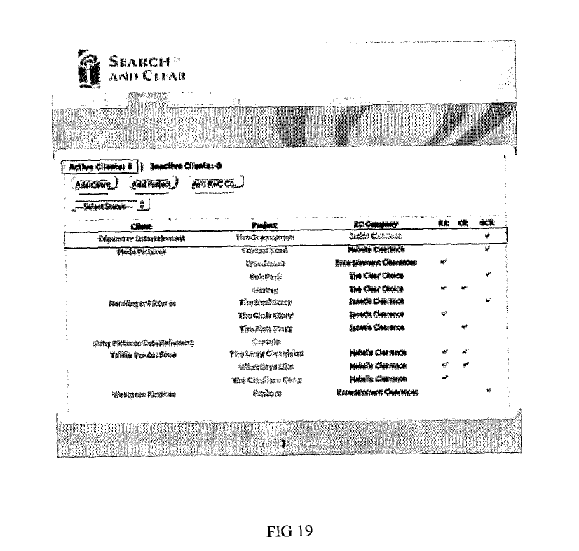

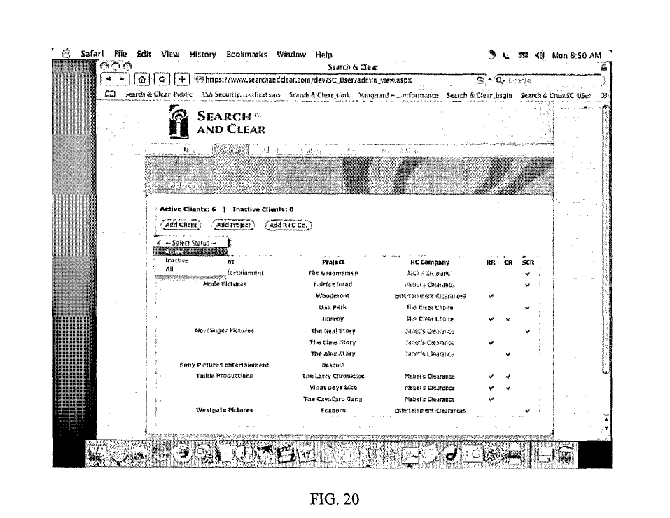

In addition to providing the platform administrator with the ability to create projects by entering clients and assigning RC companies to the project, including establishing team members from the client and the RC company, the platform also provides the platform administrator with the ability to track each of the projects currently being administered through the platform. As depicted in FIG. 19, multiple projects and their associated clients and RC companies are preferably displayed in a single web page. Additionally, the type of reports associated with each project which is preferably identified. In the preferred embodiment, the administrator page depicted in FIG. 19 may also double as another home page since it allows for viewing of either active clients, inactive clients or both. Additionally, this page also permits the addition of new clients, new projects and new research and clearance companies. Preferably, the viewing of active or inactive clients or both is determined by a drop down window allowing for selection of the desired choice. A preferred embodiment showing the selected drop down window is depicted in FIG. 20. In the preferred embodiment, if the “active” or “all projects” choices are selected, then this web page will preferably depict the most recently added project at the top of the chart. Finally, the platform administrator module provides a platform administrator with the ability to edit each of the foregoing components at any time in order to correct errors or to update changes in the client or the RC company components.

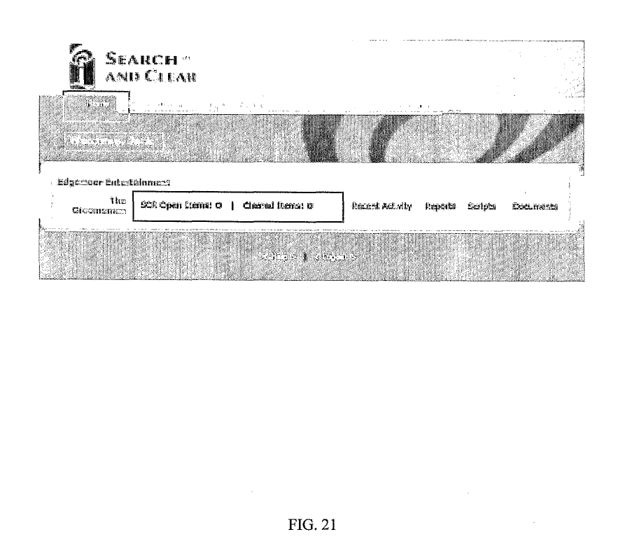

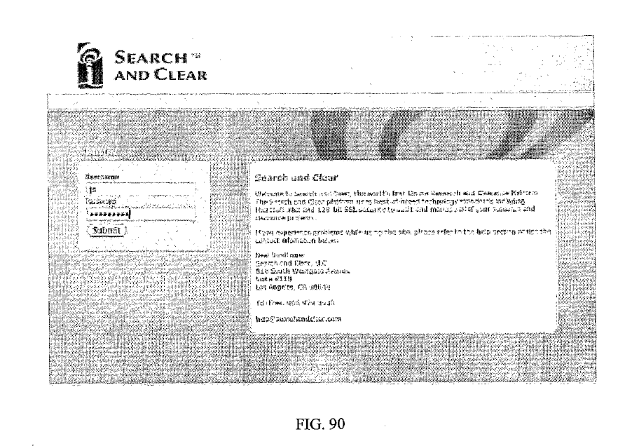

Turning now to the research and clearance module, this module is accessed by entering a user name and password on the login page depicted in FIG. 90. The platform of the current invention recognizes the user and associates the individual with the proper module of the platform. As depicted in FIG. 21, when the research and clearance administrator logs on to the platform, the opening web page identifies the user as a member of a RC company and the projects associated with the RC Company. In this instance, only one project is associated with the RC Company. Additionally, this initial web page indicates the number of open items which form the search and clearance report to be completed by the RC Company. Further, if the item is cleared, that number is also indicated. Additionally, tabs or links are available for viewing Recent Activity,” status of the “Reports,” viewing “Scripts” related to the project, and other “Documents” associated with the project. Each item is stored in a suitable database forming part of the platform.

The rights and privileges granted to each user will determine the ability to access each of these components of the platform. Further, if the user has been granted feedback rights, comments entered by the user will be stored in the suitable database. Given the proper permissions, the user may also add documents to the document database. Documents which may be added to this database can be generally in any electronic format including PDF, JPEG, GIF, word processing documents, video and audio files or other media as may be developed in the future.

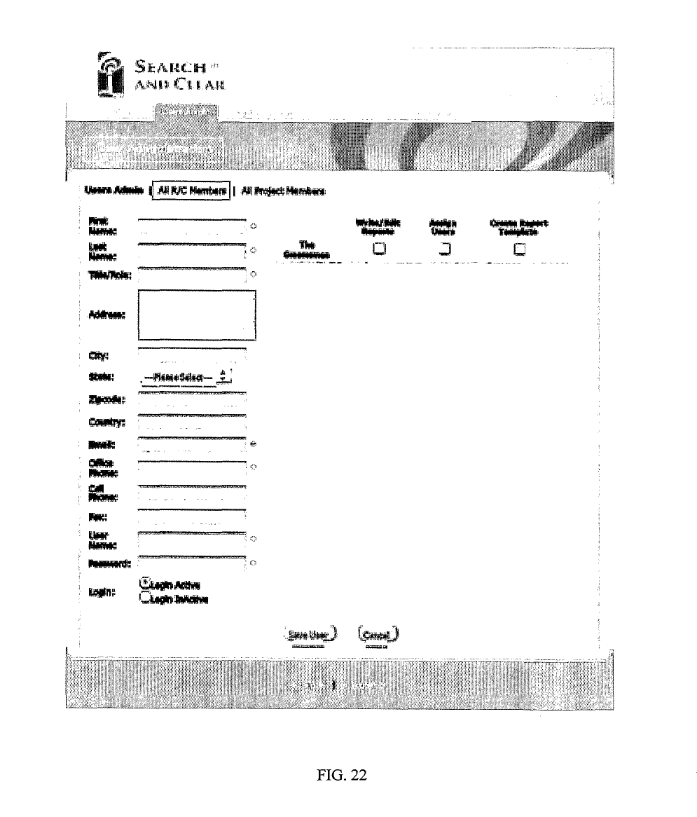

In general, the RC Administrator will determine the individuals to be added to the RC team. Thus, this module includes a component suitable for adding additional RC team members. This component of the RC module is essentially identical to the component used by the platform administrator to add the RC administrator and Client Administrator to the project. As depicted in FIG. 22, the RC administrator has the ability to add additional team members simply by entering the appropriate data in the boxes. Further, the RC administrator has the ability to grant rights and permissions to each new team member as appropriate for that person's roll in the project. Additionally, the RC administrator has the ability to review and edit their own personal data within the database to accommodate any changes in address, phone number, email, etc. following entry of the platform administrator.

In general, the RC administrator will add a suitable number of team members to the project designating each member with the appropriate title, such as head researcher, researcher, etc. Each team member, as noted above, will be provided with the appropriate rights and permissions to enter data, edit reports and assign users based on their role on the RC team.

Additionally, RC team members will typically be given the ability to view other project team members associated with the project. Thus, the RC module enables communication between all team members associated with a project including members from the Client and any additional RC companies.

Referring to the navigation bar, the RC module navigation bar differs from the platform administrator navigation bar. In particular it is noted that the navigation bar in the RC module provides access to the home page, users admin page, reports administration page, the reports, scripts and documents. The change in navigation bar reflects the different authority granted to the RC administrator as compared to the authority granted to the platform administrator. As previously described, the “Users Admin” button allows the RC administrator to add new team members associated with the RC company. From the “Users Admin” button, RC team members have the option of viewing only RC team members associated with the project or a view depicting all Project (Client) members associated with the project. Each of these views enables the party using the platform to obtain the relevant email addresses, phone numbers and fax numbers associated with a project team member. Thus the current invention provides ready access to necessary data to enhance the search and clearance process for a given project.

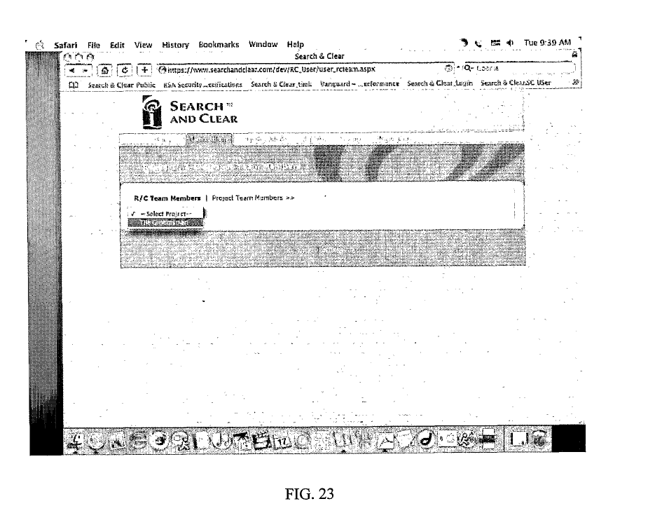

Referring back to the navigation bar, the “Scripts” button permits RC team members to view all scripts currently being handled by projects associated with the RC team. In the example shown in FIG. 23, this particular RC team is associated with only one script entitled “The Groomsmen.” Using the dropdown window, an RC team member can select the script for viewing. If the script has not previously been loaded, the RC administrator has the necessary rights to upload the script as a PDF or other format. In the preferred embodiment, the script's portion of the RC module date and time stamps the posting of the script to the database. Following addition of the script to the database, subsequent accessing of the script, by selecting the project title and clicking on the script will open a new window displaying the script for review.

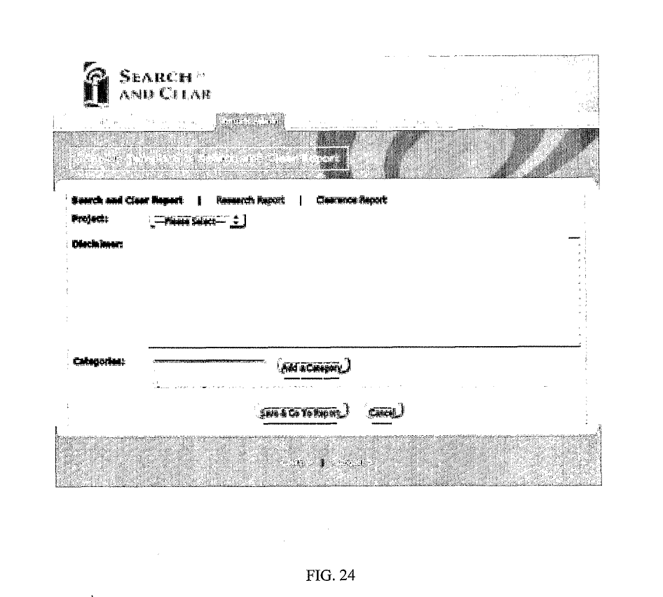

Another component of the research and clearance module comprises the “Reports Admin” button found on the navigation bar. The “Reports Admin” button provides access to templates suitable for designing research, clearance, and search and clear reports. An example of the initial template page for a search and clear report is depicted in FIG. 24. As depicted therein, the template includes a Project dropdown window, a Disclaimer box, and a Categories box. The dropdown window enables selection of a project requiring a report template. The Disclaimer box permits entry of a standardized disclaimer which will appear whenever a report is viewed by a project team member. The Categories box is populated preferable by clicking on the add-a-category button.

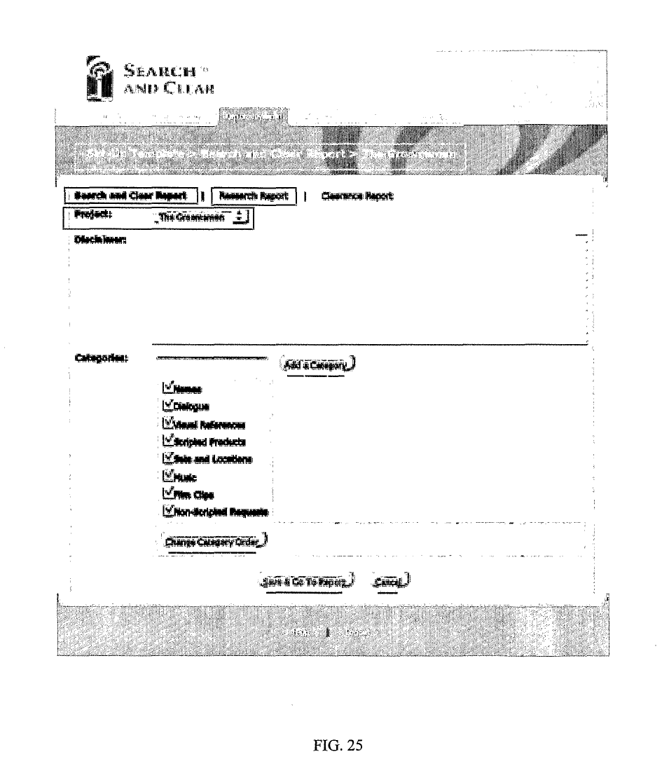

As depicted in FIG. 25, clicking on the “Add a Category button opens a new window allowing the user to select the categories to be included in the search and clear report template. In the preferred embodiment, a second button or other suitable device enables repositioning of the order of these categories with each category being selected by clicking on the check box associated with the category name. In addition to the predetermined set of categories, the preferred embodiment will permit the addition of new categories to the template.

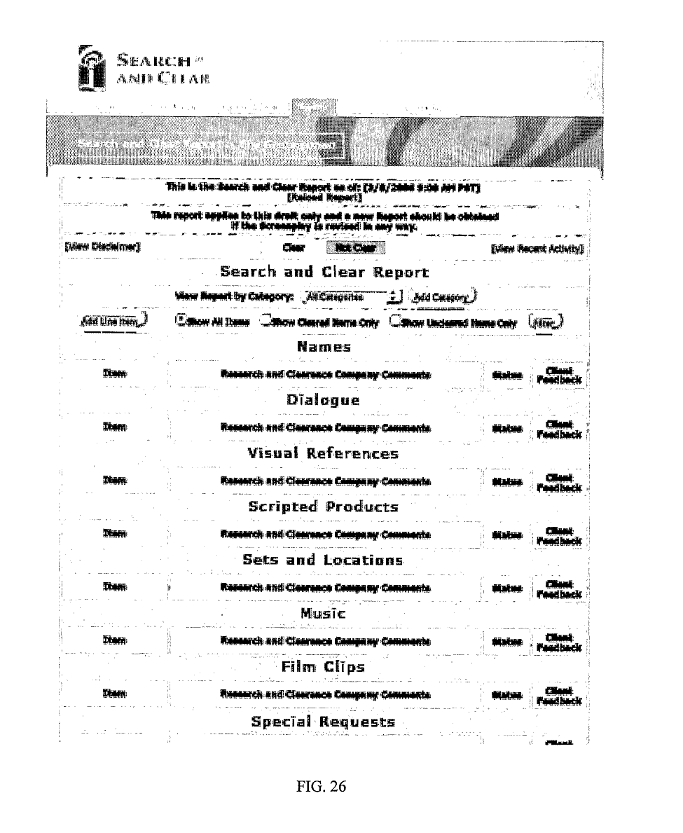

Once the report template has been established, the report associated with a given project can be viewed by clicking on the “Reports” tab in the navigation bar. An example of a configured report template is depicted in FIG. 26. As shown in FIG. 26, each category selected in the building of the template is displayed. In the preferred embodiment, the initial access of the report triggers the platform to open a second window in front of the report thereby displaying the previously entered disclaimer. Preferably, the second window includes an option allowing the user to select a mechanism whereby the disclaimer does not appear on subsequent viewings of the report.

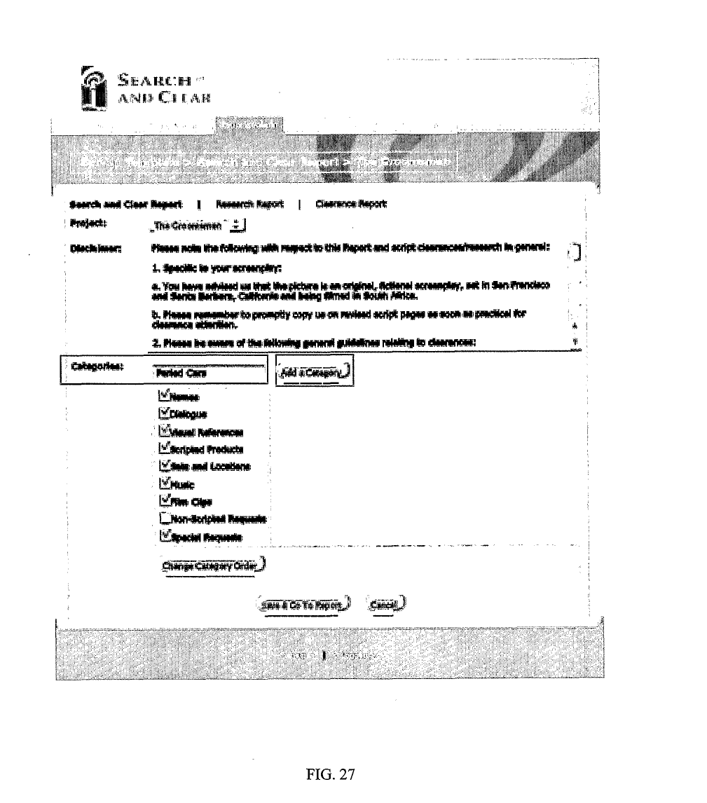

Displaying the categories in the manner shown in FIG. 26 allows for quick and easy review of the template to determine if all categories have been included. If an additional category is necessary, the research and clearance module allows the user, provided they have the proper editing permission, to re-open the reports administration button and modify the template. For example, FIG. 27 depicts the addition of a special request category labeled “period cars.” Provided that the box next to “period cars” in the categories grouping is selected, this category will subsequently appear on the template when it is reviewed in the future. Note, as depicted in FIG. 26, a user having the proper permissions may elect to add a category to the template directly from the reports page using the “Added category” button or may return to the “Reports admin” tab to add the category. As is common in website practice, many routes may provide access to any particular portion of the website.

Once the template has been established, the research and clearance module provides the ability to add items requiring clearance under the appropriate categories in the template. Items requiring clearance may include a character's name, a building view, a sound clip or other similar element of an entertainment production.

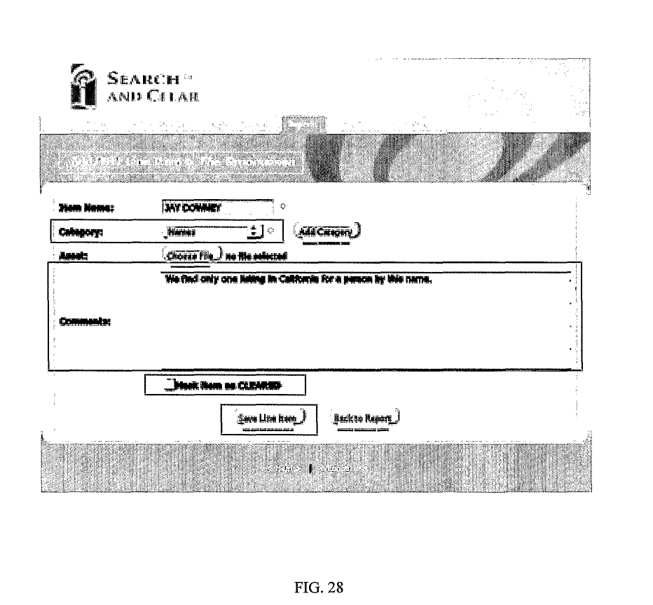

As shown in FIG. 26, the button “add Line Item” provides the mechanism for entering items under the categories. In the preferred embodiment, clicking on the “Add Line Item” button either opens a new page or refreshes the website with the page depicted in FIG. 28. As shown in FIG. 28, this page provides a box for entering the item name and a box for selecting the category to be associated with that item name. If the research and clearance project is associated with an entertainment industry project such as a movie, the item name may be the name of a character such as depicted in FIG. 28 as Jay Downey. Thus, an appropriate category to be associated with a name would be the names category. Preferably, the research and clearance module provides a drop down window on this page for easy selection of the category.

As depicted in FIG. 28, the “Comments” section provides the ability to enter comments associated with the item to be cleared. In the example of FIG. 28, the statement “we find only one listing in California for a person by this name” has been entered. Depending on the stage of the research and clearance project, the box associated with the “mark item as cleared” may be checked or unchecked depending on the status of the item. Additionally, electronic files may be included as part of the Line Item as an “Asset.” In general, the “Asset” refers to a digital file associated with the item such as an image file or an audio file. If the RC team member has the appropriate permission, they may click on the choose file button and subsequently select an asset from their hard drive or other source for downloading to the platform. In general, the report is populated with items associated with each category on the report. As the project progresses, team members will perform the necessary research to determine the clearance of each item or the need to eliminate or replace/modify an item. Additionally, the report allows the client to enter feedback for each item entered in the report. Preferably, client feedback is stored in an appropriate database along with comments from the RC team members. Thus, the platform of the current invention provides a uniform mechanism for the exhaustive analysis of the data necessary to complete the research and clearance process. Additionally, as outlined above, each user is assigned rights and permission based upon their role as a team member. Accordingly, the platform provides a hierarchical relationship between team members suitable for their roles in the project.

In a preferred embodiment, research reports generated by this module are provided with tools for optimizing viewing of the report. In particular, a drop down window is associated with the “View Report by Category” command which enables the user to select either individual categories for review or all categories for review. Thus, the report page allows a user to focus on their area of expertise in the research and clearance process.

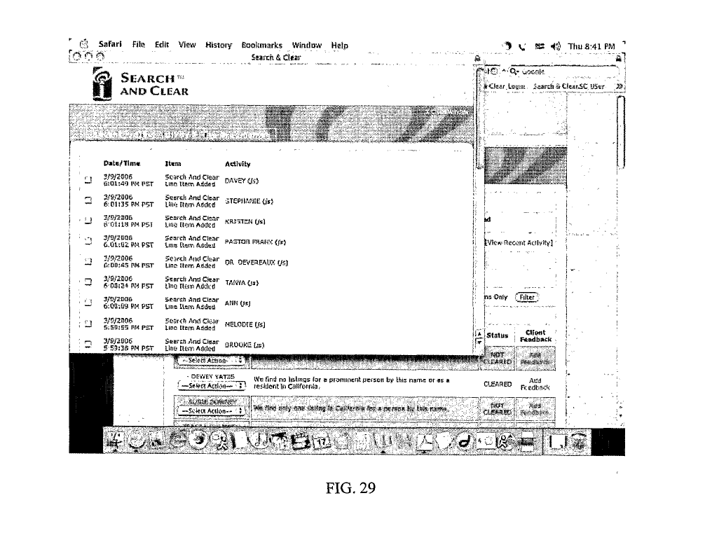

A further feature of the research and clearance module provides for viewing of recent project activity. As indicated in FIG. 26, the link entitled “View Recent Activity,” provides a user with access to a web page or a popup window depicting recent activity in the research report. In the preferred embodiment, the recent activity page displays entries in descending order with the last item entered as the first item on the list. The preferred embodiment includes a date and time column reflecting the exact date and time of the entry and an Activity column displaying the nature of the last activity relating to the item. Additionally, an Item column displays the name of the line item as an active link and the identity of the person who last altered this line item. Clicking on the link in the Item column provides access to the report page. Finally, the recent activity page can be modified by the viewer provided that the viewer has sufficient privileges to do so. This enables the viewer to maintain a manageable number of items on the recent project activity page. Removal of items from the recent activity page is achieved by checking the box associated with the item and subsequently clicking a button entitled “remove selected items (not shown in FIG. 29).”

Finally, with reference to FIG. 26, the report page provides a filter mechanism which permits showing of items based on clearance (“Show Cleared Items Only”) or non-clearance of the item. Alternatively, as depicted in FIG. 26, the “Show All Items” button may be selected. If the user desires to show only cleared items, then the button for “Show Cleared Items Only” is selected and the “Filter” button clicked. This will subsequently refresh the report displaying only those items which have been cleared for use in the project. Uncleared items may also be selected using the same approach but by selecting the “Show Uncleared Items Only.”

Access to the client's data is stored by the platform and accessible through the “Users Admin” button of the research and clearance module. Thus, a research and clearance team member having the appropriate rights and permissions may click on the “User Admin” button to gain access to the client's e-mail, fax and phone data. In the preferred embodiment, clicking on the e-mail link provided within the client's information will automatically open an e-mail message to the client. If the report is ready for viewing by the client the RC administrator may enter a message to the client and send the e-mail indicating that the report awaits feedback from the client.

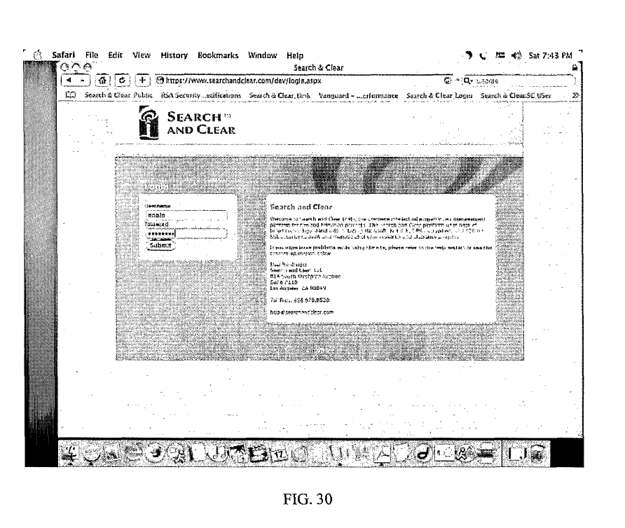

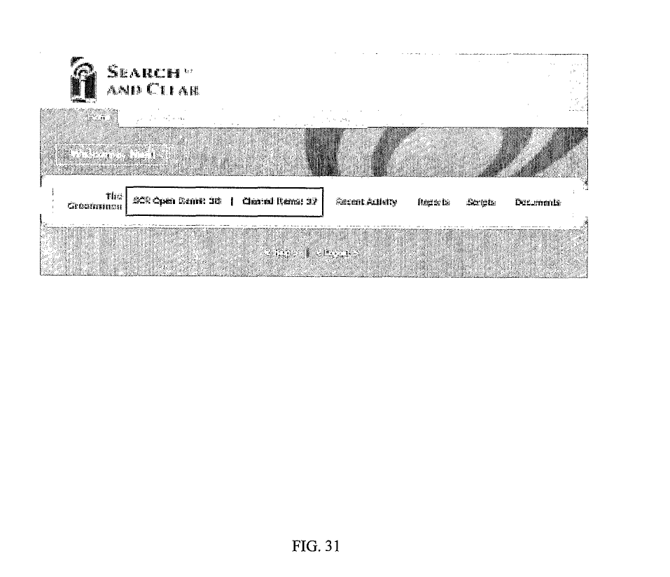

With reference to FIGS. 30-50, the client module operates in a manner similar to that of the research and clearance module. In general, this module is accessed by the client by logging onto the platform and entering a user name and a password. As depicted by FIG. 30, the log in page corresponds to the log in page for the research and clearance module. Upon successful login, the client is provided access to a client home page as depicted in FIG. 31. As shown therein, following successful log on to the platform, the client is provided with a home page which recognizes the team member by providing a welcome notice including the team member's name. Additionally, the client module home page will provide a listing of ongoing projects associated with that client and preferably associated with that particular team member of the client. For each ongoing project, the home page identifies the number of open and cleared items for the project and provides links to “Recent Activity,” “Reports,” “Scripts” and “Documents.” These links correspond to the same material found in the research and clearance module. Preferably these links will take the client user to the same data and documents associated with the ongoing project by or through the research and clearance module. Thus, the client home page allows ready access for reviewing recent activity, the status of reports, the scripts associated with the project and downloaded documents associated with the reports and recent activity.

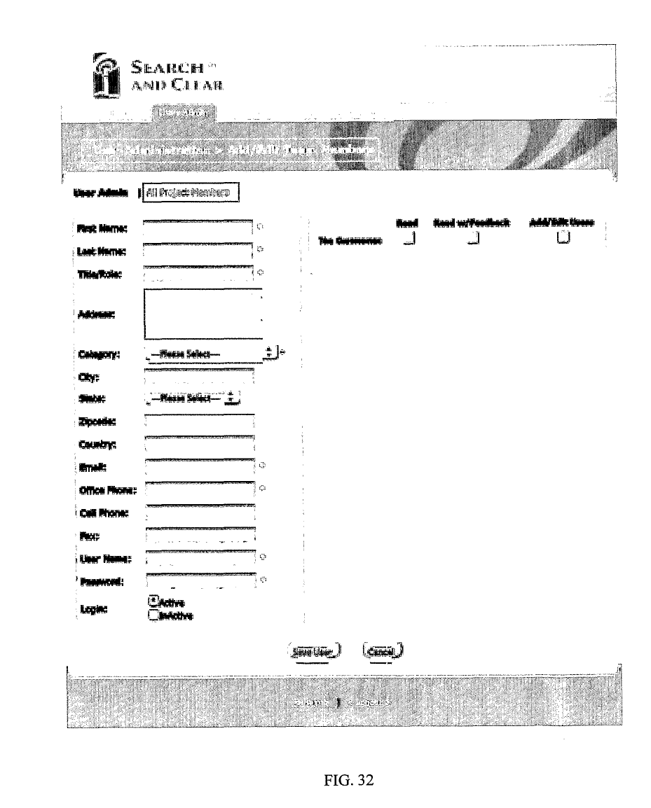

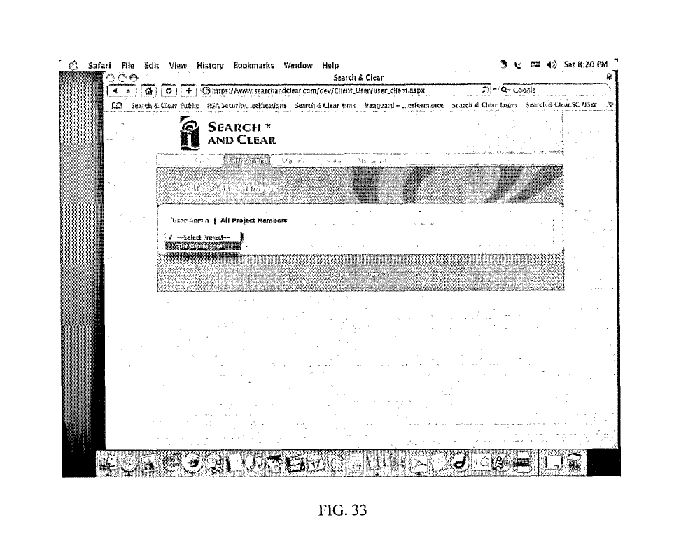

If the client team has not been completed at this time, the client module provides the ability to add additional team members to the client project team. The navigation bar present in the client module corresponds to the navigation bar in the RC module. Thus, as depicted in FIG. 32, choosing the “User's Admin” button provides the client team member with access to a web page suitable for adding additional team members to the project. From this page, the user can either add team members or select the link corresponding to “All Project Members” which takes the user to a new web page shown in FIG. 33 thereby allowing the user to view the project members for each ongoing project.

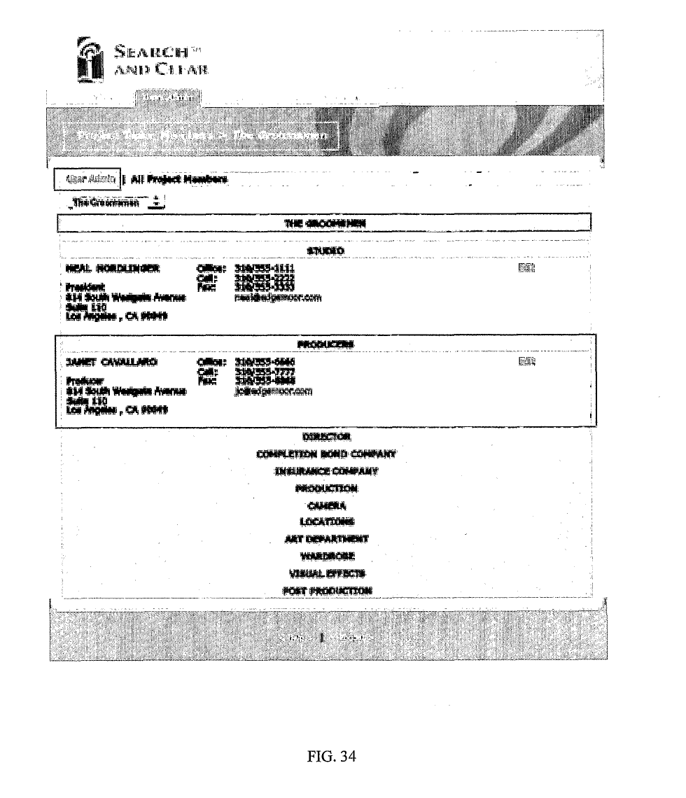

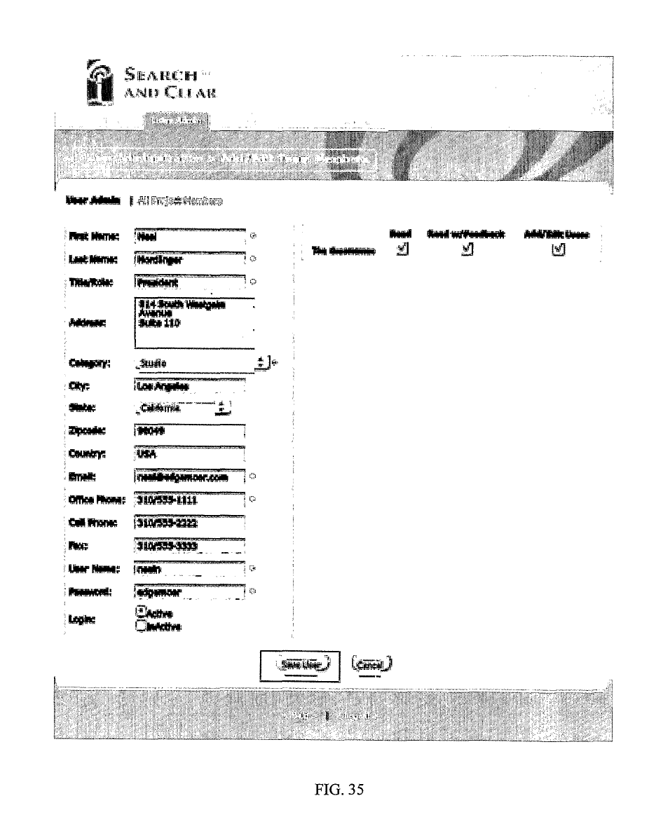

An example of a web page depicting team members in the client module is found in FIG. 34. As shown in FIG. 34, client users having the appropriate rights and permission may edit team member information by clicking on the “Edit” button or link. If the “Edit” link is selected then the user is taken to the team member's relevant information as depicted in FIG. 35. As shown in FIG. 35, this page reflects the page originally used to enter the individual's information. Thus, as in the research and clearance module, the client module allows for entry of new team members and for editing the data associated with current team members for that module. Further, as shown in FIG. 35, rights and permissions for each team member may be assigned according to their role in the project.

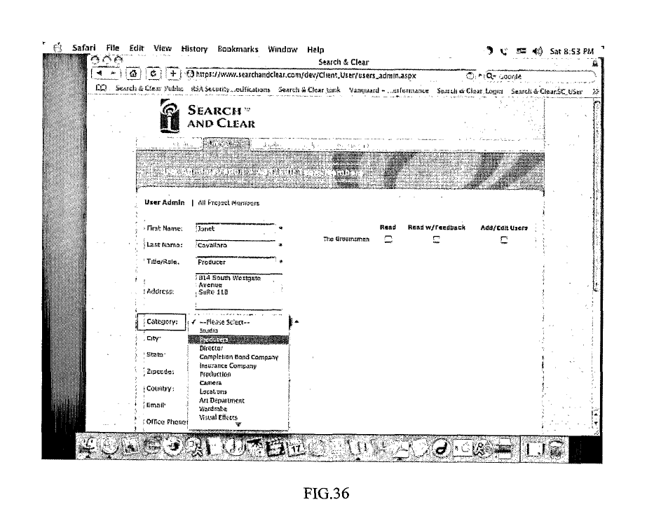

In the preferred embodiment of the client module, the web page used to enter or add new team members may be modified to accommodate the ongoing project. In the scope of an entertainment project, for example, the “Category” section typically provides a drop down window allowing the user to select the category to which the new team member belongs. An example of this type of structure is depicted in FIG. 36.

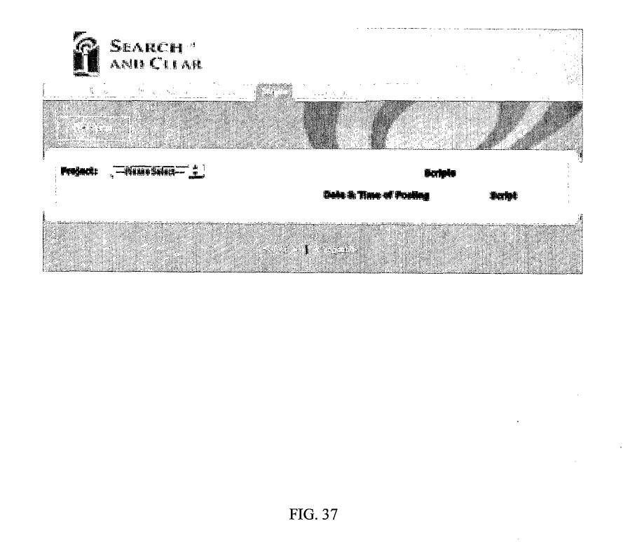

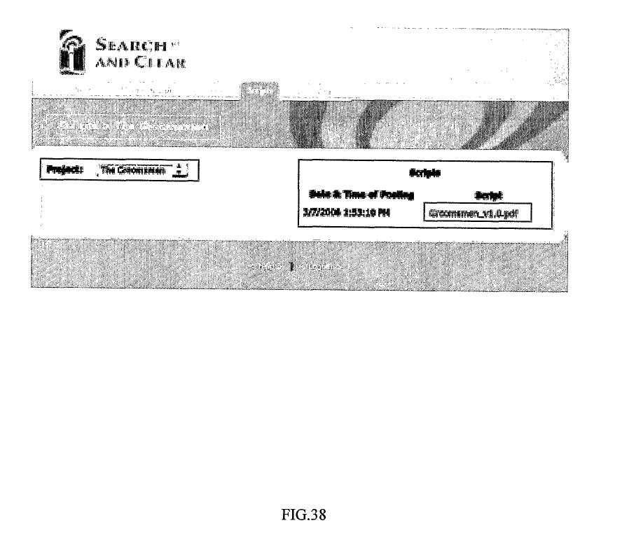

As previously indicated, the navigation bar found in the client module, operates in the same manner as the navigation bar in the other modules. In the preferred embodiment, clicking on the “Scripts” button in the navigation bar will take the user to a web page similar to that depicted in FIG. 37. Since a client user may belong to multiple teams relating to multiple projects, the Scripts page is provided with a drop down window which allows the user to select the project of interest. Once the project of interest has been selected, relative information concerning the script associated with the project will be displayed on the Scripts page. For example, in FIG. 38, this information is displayed to the right of the drop down window and indicates the date and time when the script was posted and provides a link allowing the user to access the script for viewing on their computer system. Preferably, clicking on the link for the script will open the script in a separate window. However, the system may be set up to simply open the script within the same browser window. As previously indicated, websites typically provide multiple paths to the same material. For example, as depicted in FIG. 31, the user also had the option of immediately reviewing the scripts by clicking on the “Scripts” button or link and subsequently moving to the Scripts page depicted in FIG. 38.

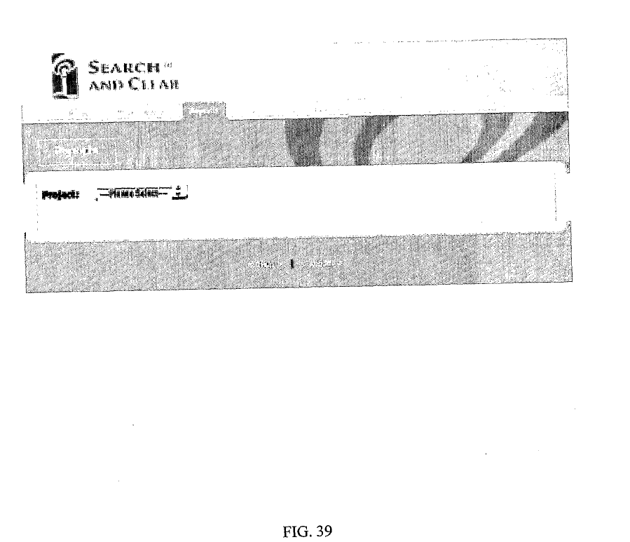

The Reports tab found on both the client user homepage and in the navigation bar will provide the client user with access to the Reports page. As depicted in FIG. 39, the Reports page also provides a drop down window allowing the user to select the project of interest.

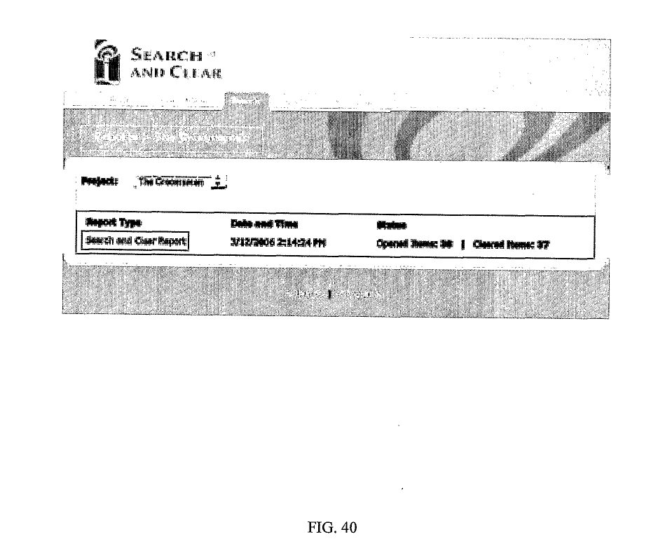

Following selection of the project of interest, the client user will be taken to a new web page which will display the current reports available for that project. Additionally, as depicted in FIG. 40, this web page also allows the client user to move from one project to another by selecting the drop down window associated with the term “Project.”

From the reports page, the client user is provided with data concerning the ongoing report and access to the report or reports applicable to the project. For example, in FIG. 40, the current status of the project, with regard to items cleared and not cleared is depicted along with the time of the most recent activity. Further, the phrase “Search and Clear Report” is a link to the relevant search and clear report.

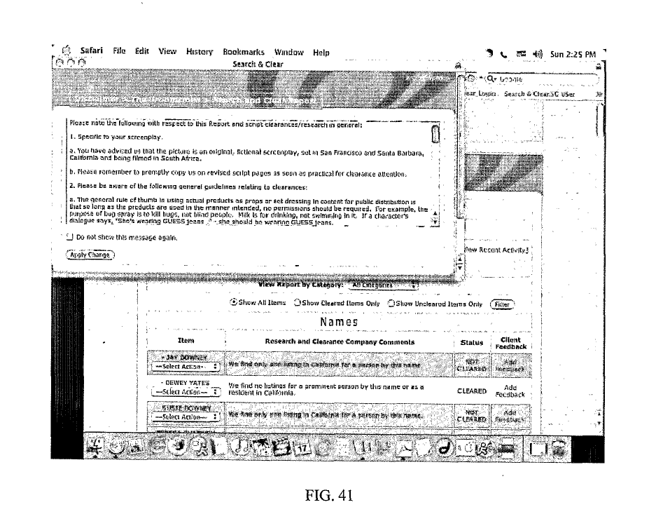

By clicking on the link, the client user will be taken to the relevant report. In this instance, the report is a search and clear report. When opened, the default view for the report preferably lists all categories included within the report. Additionally, as depicted in FIG. 41, a popup window will initially appear in front of the search and clear report. This popup window contains the disclaimer previously entered. As shown in FIG. 41, this popup window is provided with a box which allows the user to preclude appearance of this disclaimer from future showings of the search and clear report.

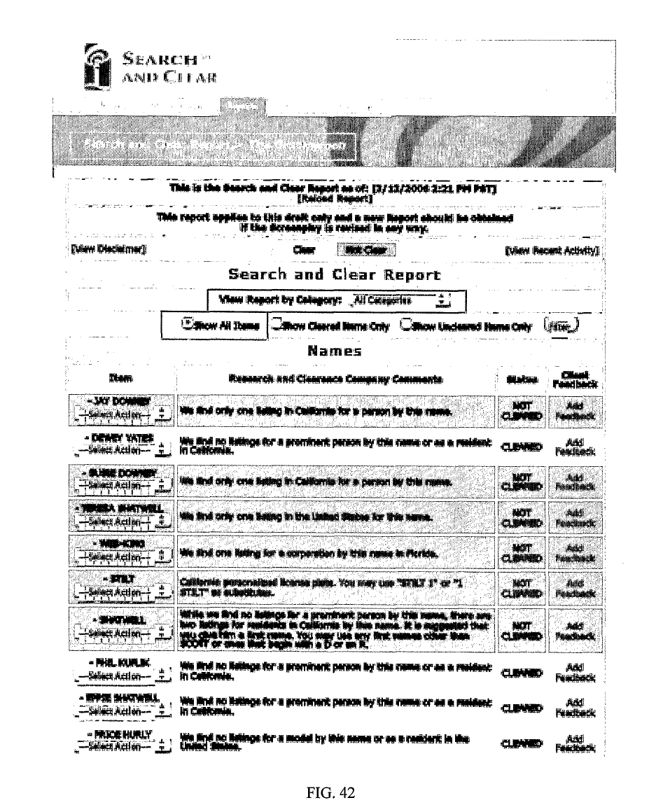

The search and clear report page depicted in FIG. 42 corresponds to the search and clear report page depicted as FIG. 26 in the research and clearance module. However, FIG. 42 now displays line items entered by the RC Team. As in the research and clearance module, the client user has the option of depicting the report by “category view” and filtering each view whether by “category” or “all categories” view through three buttons which permit showing of all items (“Show All Items”), showing of cleared items only (“Show Cleared Items Only”), or showing uncleared items only (“Show Uncleared Items Only”). The difference between the search and clear report provided through the client module and the search and clear report provided in the research and clearance module is the ability to add material to the report. In the preferred embodiment, additional items are added to the report only by the research and clearance team member using the research and clearance module.

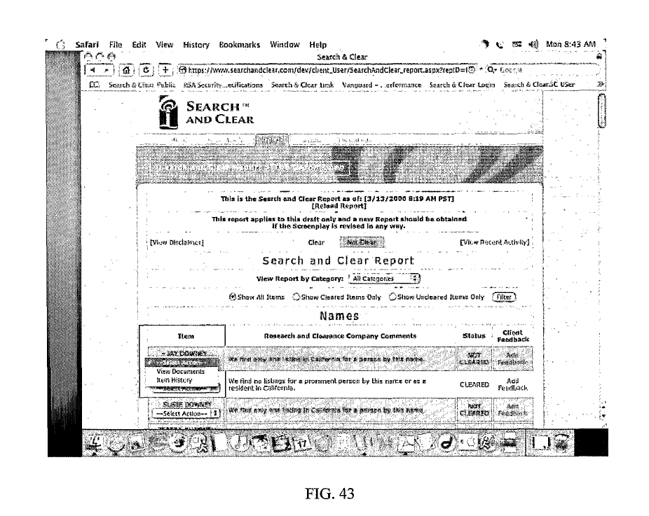

As depicted in FIG. 43, the preferred embodiment of the search and clear report page within the client module allows the client user to select a drop down item associated with each item included in the report. As shown in FIG. 43, accessing the drop down window provides a choice between “View Documents” and “Item History.” In this manner, the search and clear report provided through the client module differs from the search and clear report provided in the research and clearance mode by the absence of the “Notes” function. The notes function within the research and clearance module provides for the exchange of information between only the team members of the research and clearance company. This material is not generally available for view by the client. Further discussion of the “Notes” function is provided below.

As shown in FIG. 43, the search and clear report indicates the status of each item as “Not Cleared” or “Cleared” and provides the client with the ability to enter feedback for viewing by the research and clearance team members. A client user will provide the feedback by selecting the “Add Feedback” button or link associated with the item of interest under the “Client Feedback” column.

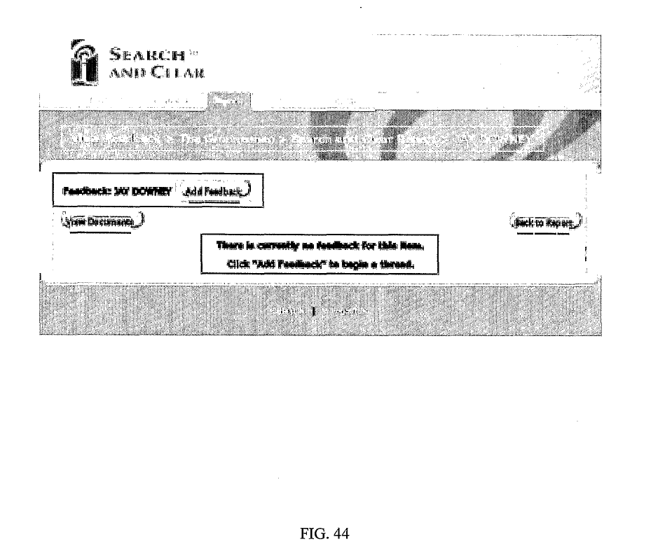

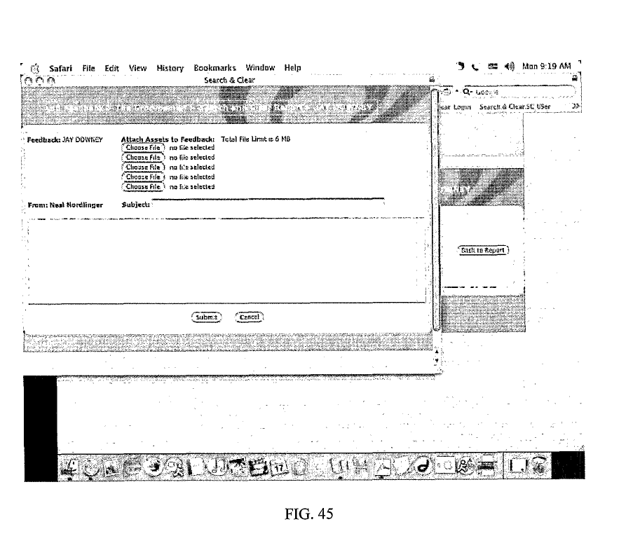

Selecting the “Add Feedback” button or link will take the user to a new portion of the reports page as depicted in FIG. 44. This page allows the client user to view documents associated with the item and to insert feedback related to the item. Selecting the “Add Feedback” button will preferably open a new window as depicted in FIG. 45.

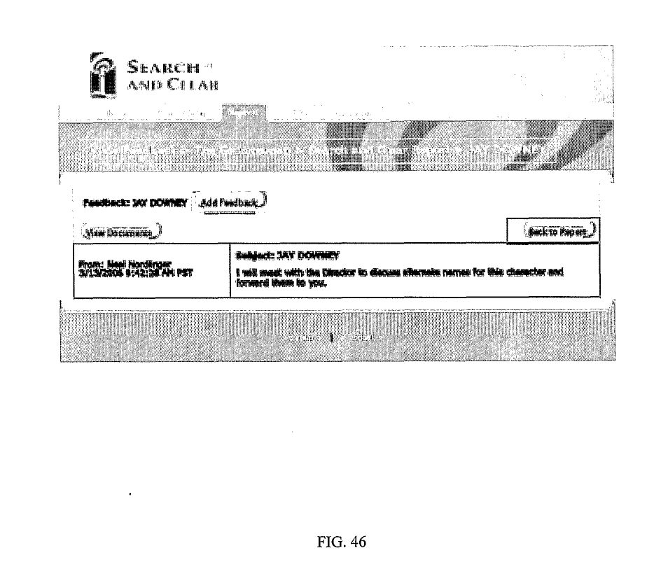

As shown in FIG. 45, the feedback window provides a subject matter line and a text box suitable for identifying the nature of the feedback as it relates to the item. Additionally, the person entering the feedback is identified. If appropriate, the client user may elect to attach a document to the feedback by selecting one of the optional “Choose File” buttons shown in the window. Although FIG. 45 indicates that the total files attached to the feedback are limited to six megabytes, this limitation will vary depending upon the application and the capabilities of the computer system running the platform. Following entry of the text within the text box and selecting the “Submit” button, the user will be returned to the View Feedback page. In this instance the View Feedback page will change as depicted in FIG. 46. As shown therein, the feedback is provided for the viewer on the feedback page and is date stamped with the date and time of the feedback along with the name of the contributor

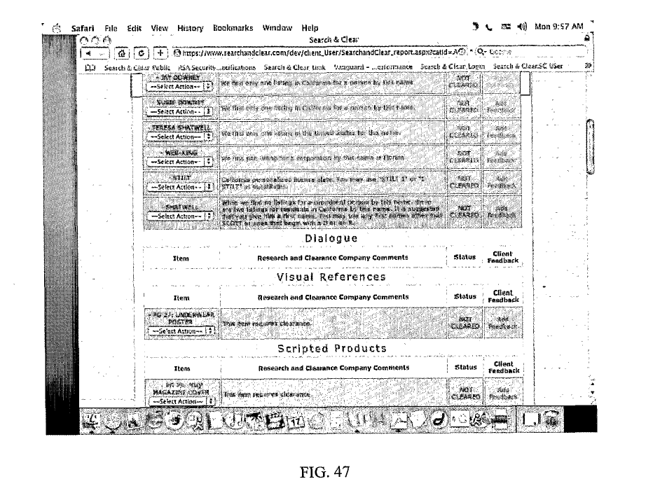

Subsequent users of the search and clear report will be alerted to the presence of feedback for the item in the final column as the notice “Add Feedback” has changed to the term “View Feedback” depicted in FIG. 47.

In the preferred embodiment, subsequent users logging on to the platform will be able to read the feedback provided the earlier users. Additionally, if the subsequent user is a user having rights to read and provide feedback, the “View Feedback” notice will preferably be highlighted either by bolding of the text or a change in color thereby alerting the user to the change in state of the search and clear report. As is common to website design, once the subsequent user views the feedback the highlighting or bolding will revert to a normal text while still reading View Feedback.

The client module also provides the ability to review recent activities within the project. Access to the recent activity may be gained through the “Recent Activity” button or link found on the client module homepage as depicted in FIG. 31. Selection of this button preferably opens a new window similar to the recent activity window previously discussed with regard to the research and clearance module.

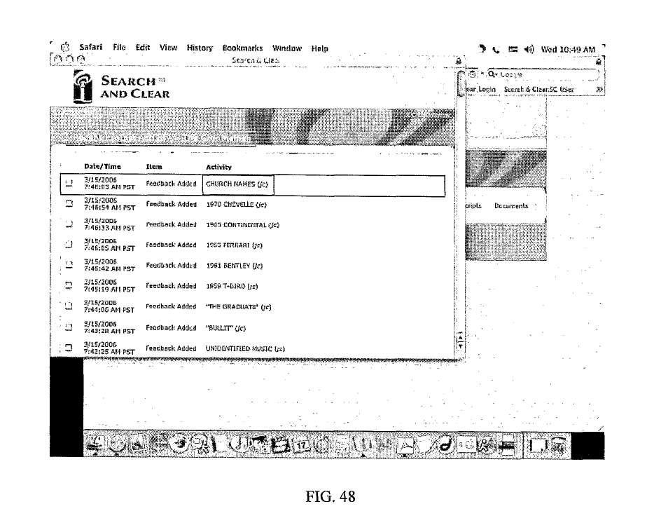

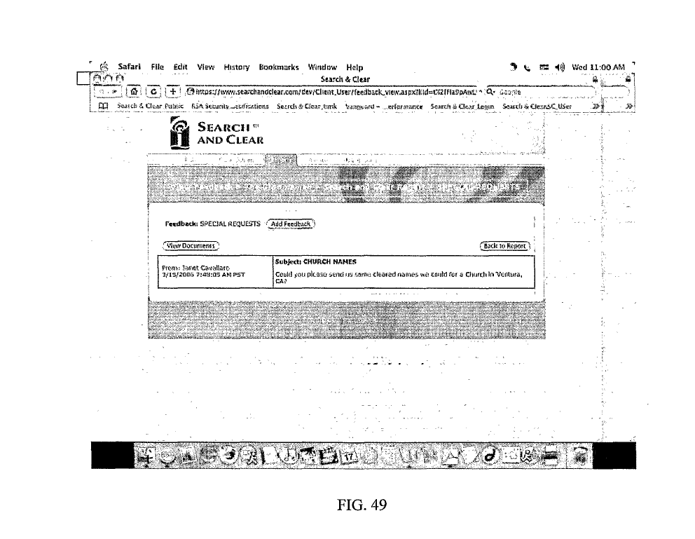

As depicted in FIG. 48, the recent activity window is preferably in date order with most recent activity listed at the top. The window further provides a column indicating the type of activity and the category to which it relates. (Note: due to a typing error the “Activity” and “Item” columns were inadvertently reversed in FIG. 48). Preferably, the user can delete recent activity by selecting the box on the left associated with that particular item and clicking the update button or other similar function button. Further, if a user selects the link for the Item underneath the “Item” column the user will be taken to a web page depicting the nature of the recent activity. An example of such web page is found in FIG. 49.

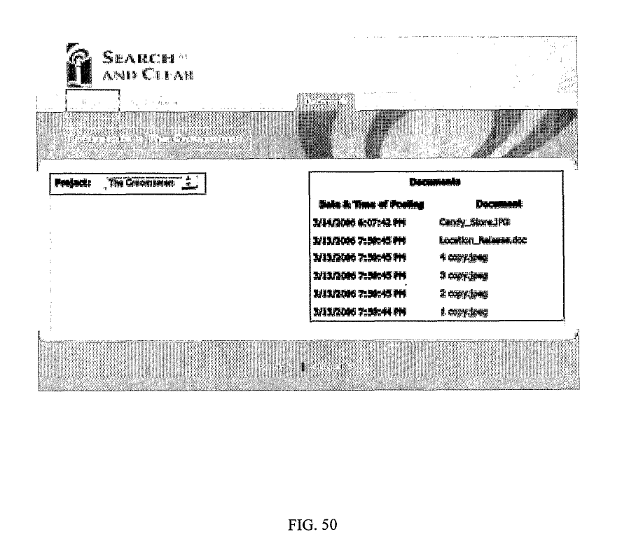

As shown in FIG. 49, this page corresponds to the View Feedback page and permits viewing of documents associated with the feedback by selecting the “View Documents” button or link. Finally, the client module home page also permits viewing of documents directly from the home page which are associated with the ongoing project. Selecting the “Documents” tab or button either from the project line or from the navigation bar will provide the user with access to those documents associated with the project. An example of a Documents page is depicted in FIG. 50.

The method of the current invention will be described in the context of a new project directed to searching and clearing items related to a film production entitled The Groomsmen. In this context, the platform administrator needs to add the project to the platform and identify the client, Edgemoor Entertainment.

To start the process, the platform administrator logs on to the platform by entering a username and password. If the entry is accepted, the platform administrator is taken to the homepage depicted in FIG. 1. As discussed above, a typical platform administration homepage indicates the number of logged on users, current active and inactive clients, current active projects and inactive projects. Additionally, this page provides the ability to access each of the above as well as the ability to add new clients and projects.

Since Edgemoor Entertainment is a new client, the platform administrator selects the “new” button adjacent to the “select client” drop down window. This action takes the platform administrator to the page depicted in FIG. 2 thereby allowing the administrator to enter the relevant data necessary to add Edgemoor Entertainment as a client. As previously discussed, at least those boxes highlighted with an asterisk or other callout insignia must be completed in order to add a client to the platform. If Edgemoor Entertainment had an associated logo or trademark, the platform administrator would have the option of adding that symbol to the active client file by choosing the button labeled “choose file” located to the right of the term “Logo”.

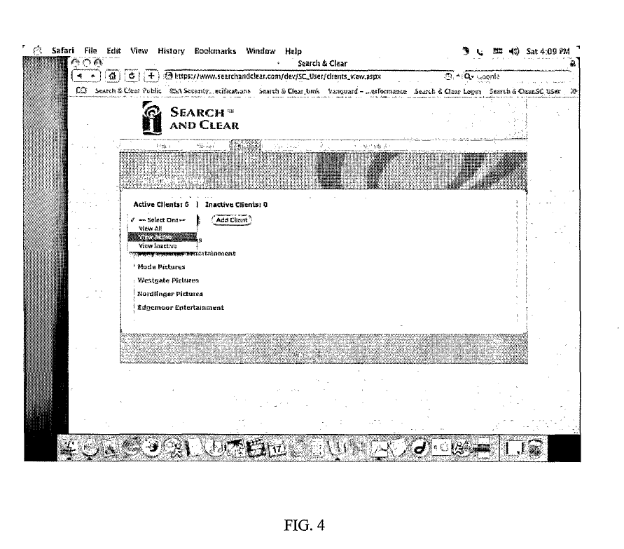

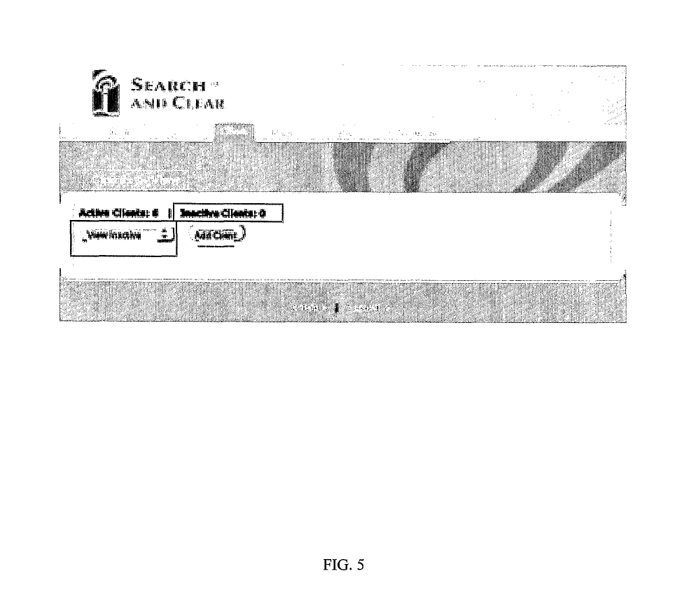

Following addition of Edgemoor Entertainment to the platform as a client, the platform administrator can confirm the addition has been accepted by the platform by clicking on the “Clients” tab found in the navigation bar across each page of the platform administrator module. When this tab is selected, a page such as that depicted in FIG. 3 appears indicating the current active clients. As indicated in FIG. 3, this page also provides the option of adding additional clients. Further, the drop down window entitled “select one,” as depicted in FIG. 4, allows the platform administrator to toggle between “view all,” “view active” and “view inactive” with regard to the clients. In the preferred embodiment, the “view active” is the default setting. Selecting the “view inactive” option refreshes the screen as shown in FIG. 5, reflecting that there are currently no inactive clients.

Following determination that the client of interest is stored within the database of the platform, the platform administrator will need to add the project to be associated with Edgemoor Entertainment. Since the navigation bar is normally available in each present page view found in the platform administrator module, the administrator may simply select the “Projects” tab from the navigation bar.

Alternatively, the platform administrator may return to the homepage and select the button labeled “new” adjacent the “Select Project” drop down window. Either route enables the platform administrator to add a project to the platform. For example, selecting the “Projects” tab from the navigation bar will take the platform administrator to the “Projects” page which preferably defaults to the active projects view. This page also indicates the number of inactive projects. The administrator has the option of toggling between “active,” “inactive” and “view all” projects using the drop down window shown in FIG. 6 and further shown in FIG. 7.

By selecting the “Add Project” button, the platform administrator will be taken to the project add/edit page. An example of this page is depicted in FIG. 8. In a manner similar to the Client Add/Edit page, the platform administrator must at least complete those boxes indicated with a star or other highlighted indication in order to successfully add a project to the platform. Additionally this page provides the administrator with the option of adding a logo or other insignia associated with the project by selecting the “Choose File” button adjacent to the term “Logo”. If this button is selected, then the administrator will have the ability to select a file from the computer's hard drive or other source and add it to the database contained within the platform. Once the necessary data is entered within the “Project Add/Edit” page, the platform administrator selects “Save Project” in order to add the project to the platform.

Continuing with the process of building the project, the platform administrator will preferably select a research and clearance company for the project entitled The Groomsmen. Access to current RC companies within the platform may be gained by selecting the “R/C” tab in the navigation bar. When the platform administrator selects this tab, he gains access to the R+C Companies view depicted in FIG. 9. This page depicts RC companies currently active on a project within the platform and also indicates that there is one inactive RC company not currently performing services using the platform. In the preferred embodiment, the “view active” setting is the default setting.

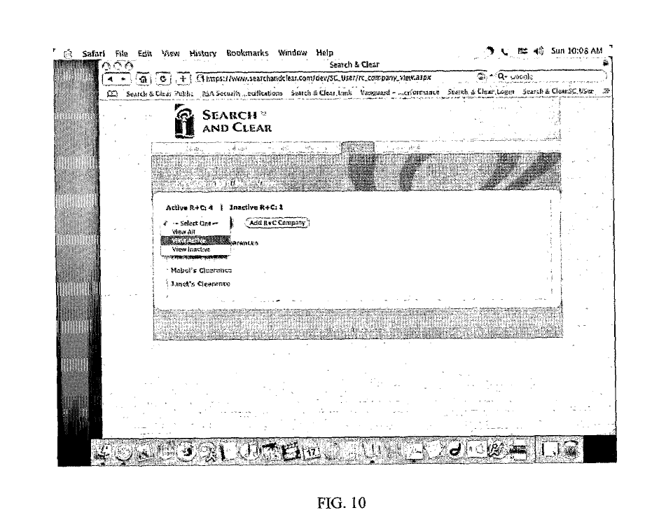

If an additional RC company is desired, the platform administrator may add the company using the “Add R+C Company” button. In a manner similar to the Client Add/Edit and Project Add/Edit pages, the RC company page allows the administrator to toggle between views which depict all RC companies listed within the database, only active companies within the database and only inactive companies within the database. An example of such a view is found in FIG. 10. In this instance, a new research and clearance company is desired; therefore, the platform administrator will select the “Add R+C Company” button. Selection of this button provides the administrator with access to the RC Company Add/Edit page as depicted in FIG. 11.

As shown in FIG. 11, the R/C Company Add/Edit page enables not only the addition and editing of information related to an RC company, this page also allows for association of the company with an ongoing project. This association is enabled by the box on the right hand side of the screen and provides identification of the type of report to be performed by the company. As noted above, RR indicates a research report, CR indicates a clearance report and SCR reflects a search and clearance report. The platform administrator simply selects the appropriate box for each project to be handled by the RC company. In this instance, FIG. 12 reflects a completed RC company entry including the association of the company Jack's Clearance with The Groomsmen indicating a search and clearance report to be filed.

Following entry of the RC company to perform the services for The Groomsmen project, the platform administrator has the ability to review each of the prior entries including the new client, the new project and the new RC company by returning to the appropriate add/edit page or the Clients View page as depicted in FIG. 3, the Projects View page as depicted in FIG. 6 and the R+C Companies View page as depicted FIG. 9. Following the additions, each of these pages will be updated to reflect the new data added to the platform.

In order to advance the project, the platform administrator must add at least one team member associated with the client and at least one team member associated with the RC company. The process of adding team members is carried out using the “Users Admin” button found in the navigation bar. Selection of the “Users Admin” button will transfer the platform administrator to the User Administration page. An example of this page is found in FIG. 13.

In this case, the User Administration page has been partially completed by entering the president for Edgemoor Entertainment and indicating the rights and permissions granted to this individual. In this instance, the company has already been associated with the company's project, The Groomsmen. Additionally, the president has been granted full rights within the client module to be discussed below. As indicated in FIG. 13, the president has the right to read, provide feedback and add or edit users within the client portion of the team carrying out the project.

The example shown in FIG. 13 has not fully been completed inasmuch as text boxes starred remain empty for e-mail, phone and desired password. Once these boxes are completed by the platform administrator, the president will have access to the platform by logging on and entering a user name and password. As indicated in FIG. 13, it is clear that this particular user is associated with the client inasmuch as the User Type which is selected using a drop down window has been identified as Client User.

The platform administrator has the option of adding additional team members to the client, Edgemoor Entertainment. However, in general, additional team members will be added by the president or team lead for the client. Finally, as indicated at the end of the text boxes for entry of the new client or RC company team member, the log in status of the individual defaults to the active status. If this individual is considered an inactive user, then the platform administrator must select inactive.

Following entry of the team member, the platform administrator may select the link entitled “All Project Members” which will refresh the screen with the project team members' view as depicted in FIG. 14. From this view, the platform administrator may use the drop down window to select a client and then use the filter button to the right of the drop down window to select a “view all” or a view for a specific project. An example of this drop down window is shown in FIG. 15. In this instance since only one team member has been added both options will display only the president, Neal Nordlinger.

Entry of the first team member for the research and clearance company is carried out in a similar manner to the entry of the first team member for the client. In this instance, the platform administrator returns to the User Administration page by selecting the “Users Admin” button from the navigation bar. Once again, the page is refreshed with the text boxes necessary for adding a team member. As shown in FIG. 17, the user type box provides a drop down window allowing the platform administrator to select R/C user when adding a team member for the research and clearance company. Upon entry of the company name, the project with which that company has been associated automatically appears on the right hand side of the user administration page. In this instance the company, Jack's Clearance, has only been associated with The Groomsmen, therefore only one project appears. Further, as depicted in FIG. 18, the president, Jack Smith, has been granted full rights to write and edit reports assigned users and to create report templates for this project. Once all of the data is complete on this page, the platform administrator selects “Save User” and this user will then have access to the platform by entering a username and password within the log in page.

With reference to FIG. 18, the user administration page includes a link entitled “All R/C Members.” This link provides the platform administrator with access to a subsequent web page, not shown, but similar to the project team members' web page depicted in FIG. 14. As in that web page, the drop down window in this case will depict current research and clearance companies. Following selection of the relevant company, the administrator will select the project associated with that company in order to view all team members currently stored within the platform. In this instance only one team member has been added; therefore, only one team member will be viewable within this mode.

Upon completion of the steps necessary to add the client to the project, add the research company as well as establishing one team member for the client and the research and clearance company, the platform administrator will typically select the “Admin” tab from the navigation bar. This tab refreshes the window with the default view of the administration page. As shown in FIG. 19, the administration page provides more detail concerning ongoing projects and clients than the home page depicted in FIG. 1. In this instance, the admin page allows for the addition of clients, projects or RC companies, however, the page also indicates the currently active clients associated with their projects and the RC company carrying out the research and clearance for each project. Further, the type of report being completed is indicated. The default view for the Admin page is preferably active only. However, the drop down window associated with the “Select Status” box permits toggling between the “active,” “inactive” and “all” views for the platform. An example of the drop down window is depicted in FIG. 20.

In the preferred embodiment, each of the entries under Client, Project and RC Company columns are clickable links. By selecting either the client name, the project name or the RC company, the platform administrator will be taken to the appropriate add/edit page for the client, the project or RC company. In this manner, the platform administrator may view the client, project or RC company to confirm that the information entered is correct.

Upon verification that all information has been entered correctly, the platform administration will preferably notify both the RC company and the client that work may proceed on the project using the platform. Notification to both parties may be sent via e-mail using the information stored on the platform.

Upon receipt of notification from the platform administrator, the president for Jack's Clearance (the RC Administrator) will preferably log onto the platform by entering a username and password. On successful entry into the platform, the president sees the homepage, depicted in FIG. 21, including a welcome banner utilizing the president's first name “Jack.” Viewing the RC company homepage, the president is informed that his company has been assigned a search and clear project for Edgemoor Entertainment with the project name, The Groomsmen. Since the report template has not been completed at this time, the status for the search and clear open items and cleared items are both indicated as zero. Thus, the user will recognize this as a new project.

Additionally, the home page provides access to recent activity for the report, access directly to the reports, the scripts and any documents associated with the project. Further, as in the administrator module, the research and clearance homepage also provides a navigation bar with tabs entitled “Home”, “Users Admin”, “Reports Admin”, “Reports”, “Scripts” and “Documents.” In general, the navigation bar will be present on each page within the research and clearance module. Thus, RC team members, depending on their rights, will have ready access to these fields regardless of the page which they are viewing.

The “User Admin” button provides access to a page which enables addition of team members as well as the ability to view all current RC members or all current project members. Selection of either view is achieved by clicking on the link appropriately entitled. At this time, only one team member, the president, will be found under the all RC members listing. If the president wishes to confirm that the data found within his entry is correct, he may select the “All RC Members” link and view information associated with his name. Since he has been granted permission to assign and edit users, he will have the ability to edit the entry associated with his name.

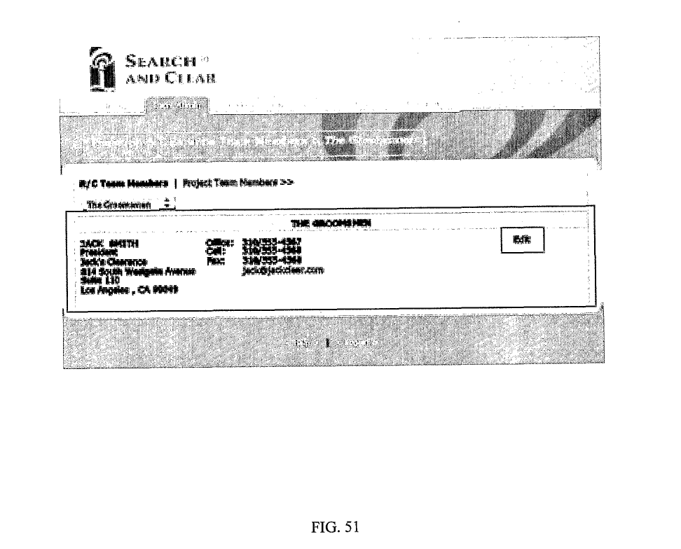

Following a brief review of the homepage, the RC administrator will typically check the status of those who have permission to work the selected project. This status check is enabled by selecting the “Users Admin” tab in the navigation bar. Selecting this tab will take the user to the RC Administrator to the User Administration page which includes links entitled “All R/C Members” and “All Project Members”. As would be suggested by the titles of the links, clicking on the “All R/C Members” link will allow the RC administrator to view only research and clearance team members assigned to the project. In the preferred embodiment, clicking on “All Project Members” link will bring up a display of client members. Additionally, as depicted in FIG. 22, the User Administration page allows the RC administrator to add team members to the RC team. As team members are added, the RC administrator typically assigns rights and permissions to each member. Further, this page will also grant the RC administrator access to the data for each RC member allowing the RC administrator to edit that data. As depicted in FIG. 51, the current RC team consists solely of Jack Smith, the RC administrator. Editing the data for Jack Smith would be accomplished by selecting the “edit” button next to his name.

In the preferred embodiment, the RC administrator selects the User Admin button to obtain access to the User Administration page. Following access to this page, the RC administrator adds additional team members in order to carry out the research and clearance project. In a manner similar to that used by the platform administrator to add the RC administrator to the platform, the RC administrator will add each team member by completing the relevant boxes depicted in FIG. 22. As shown in FIG. 22, the User Administration page defaults such that each added member is automatically considered an active member. If the RC administrator adds a team member who will not be actively involved immediately in the project he would have the option of selecting inactive for the log in portion thereby limiting the member to viewing the system only or completely precluding access by that member.

For the purposes of this example, we will assume that the RC administrator adds a head researcher and designates the same in the title role box provided. Further, the head researcher will typically be granted all rights and permissions by checking each of the boxes next to the project The Groomsmen. Thus, the head researcher has the ability to write/edit reports, assign users and create report templates. Once the RC administrator has completed filling in the text boxes related to the head researcher, the RC administrator will save the user by clicking on the “Save User” button toward the bottom of the page.

At this time, the RC administrator has the option of adding another member or selecting the “All RC Members” link to view the current team. If the RC administrator views the current team, then he will need to click on the “Users Admin” button to return to the Users Administration page to add additional members. In this instance, the RC administrator adds an additional team member but does not grant this team member full rights. Rather, additional team members may be granted selective rights depending upon their related roles. For example, this team member would preferably be granted the right to edit or write reports only as it is not preferred to have too many team members assigning users and creating report templates.

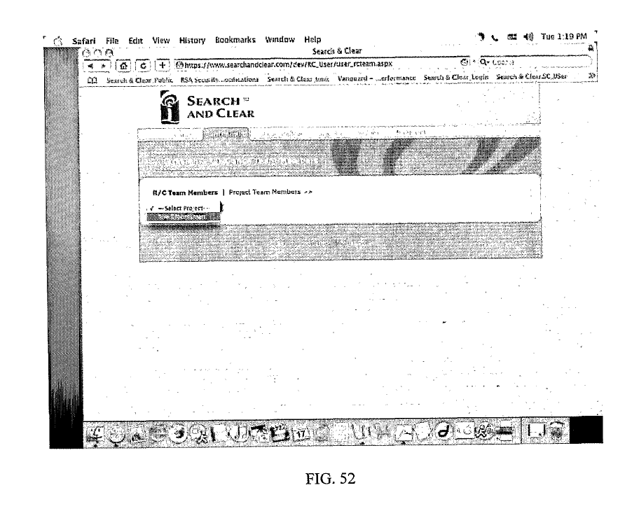

Following selection of the RC project team, the RC administrator may wish to view all project team members currently assigned to the project. This is accomplished by selecting the “All R/C Members” link which refreshes the window with the Research and Clearance Team Members' page. As depicted in FIG. 52, selecting from the pull down window, the client name “Edgemoor Entertainment” will refresh the window with an R/C team member's page associated with Edgemoor Entertainment.

While the preferred embodiment and this example assumes that the RC administrator has accessed the platform prior to the client administrator, no such limitation exists in the operation of the platform. Rather, both parties could access simultaneously or the client administrator may access the platform prior to the RC administrator. Thus, this view is merely an example and it would be possible for the client project team to have been fully populated prior to the RC administrator viewing the project team members.

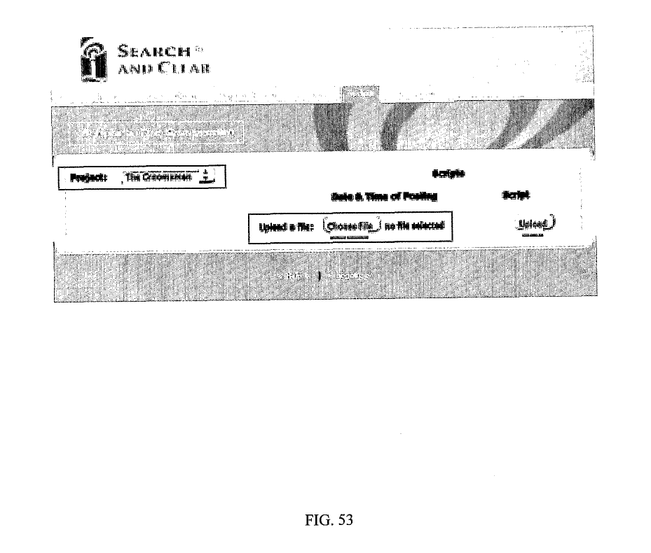

Having established the current team members for the RC project team, the RC administrator needs to initiate the research and clearance process by uploading data to the platform. In particular, the RC administrator needs to upload at least the production script associated with this project. This process is carried out by selecting the “Scripts” tab from the navigation bar. As depicted in FIG. 23, selection of the “Scripts” tab opens a web page entitled Scripts and provides a drop down window which grants the RC administrator access to all projects currently assigned to the RC company. In this instance, the only project assigned to the RC company is The Groomsmen. As such, there is only one project displayed in the drop down window. Selecting The Groomsmen, will provide the RC administrator with access to a page as depicted in FIG. 53. As shown therein, the RC administrator is provided with a button or tab entitled “Choose File.” By selecting this button, the RC administrator is given the ability to download a script from his computer or other electronic media to the platform.

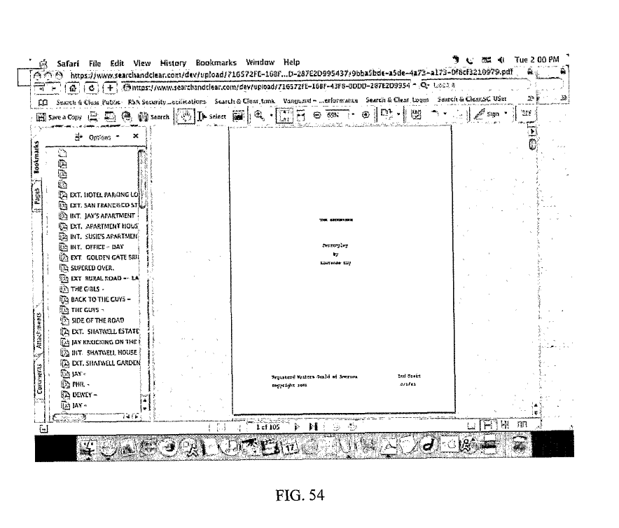

Once the script has been loaded to the platform, the RC administrator may verify that the script is accessible to parties through the platform by clicking on the link provided. In the preferred embodiment the link will identify the script by name and version. Selecting this link will preferably open a new window displaying the script in the form in which it was loaded. Typically the preferred format for scripts will be a PDF format. An example of the window depicting the loaded script is depicted in FIG. 54.

Once the script is available to the team members, the RC administrator needs to create the report form to be used during the project. The process for creating the report is enabled by selecting the “Reports Admin” tab in the navigation bar. Selection of this tab will provide the RC administrator with a webpage such as depicted in FIG. 24. As shown in FIG. 24, the RC administrator has the option of creating one of three reports: a “search and clear report”, a “research report” and a “clearance report.” Additionally a drop down window is provided to enable selection of the current project of interest. Below the drop down window is provided a text box which allows the RC administrator to create a disclaimer applicable to the report to be provided. Finally, below the disclaimer box is provided a “categories” box which allows the RC administrator to create a template by selecting the categories of interest relevant to the production to be searched and cleared.

In the preferred embodiment, the platform administrator has already selected the type of report to be provided by the RC company. Thus, selecting the project name will automatically establish the default report template. However, the RC administrator has the option of clicking on the other report links to confirm that he has selected the proper link for forming the template.

In this instance the proper link is the “Search and Clear Report.” As a result, clicking on the other links will yield an empty box for the pull down window associated with the project.

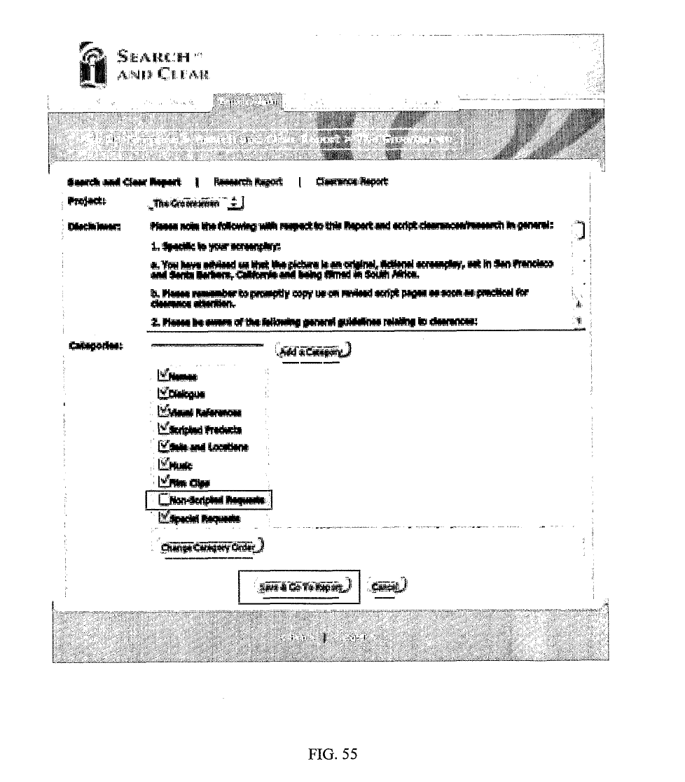

Once on the Setup Template page, the RC administrator preferably types or cuts and pastes the desired disclaimer into the disclaimer box. This disclaimer will be posted on the platform and will appear when the report is viewed. Additionally, the RC administrator will select the categories applicable to the current project. Preferably, there will be a set number of default categories which will automatically appear in the report. In the example depicted in FIG. 25 eight categories are provided. Additionally, the RC administrator may add any number of custom categories via the categories field by entering in the blank field a designated term such as “special request” and selecting the button “add a category.” This process will refresh the page with a new category labeled special requests added at the bottom of the category list. The RC administrator will subsequently check the box next to the “special request” category to make it active and if necessary will uncheck appropriate boxes from the default categories if they are not desired. An example of this is displayed in FIG. 55. When the RC administrator selects the “Save and Go to Report” button, the computer screen will be refreshed with the Search and Clear Report” page for the particular project. An example of such a page for The Groomsmen is depicted in FIG. 26.

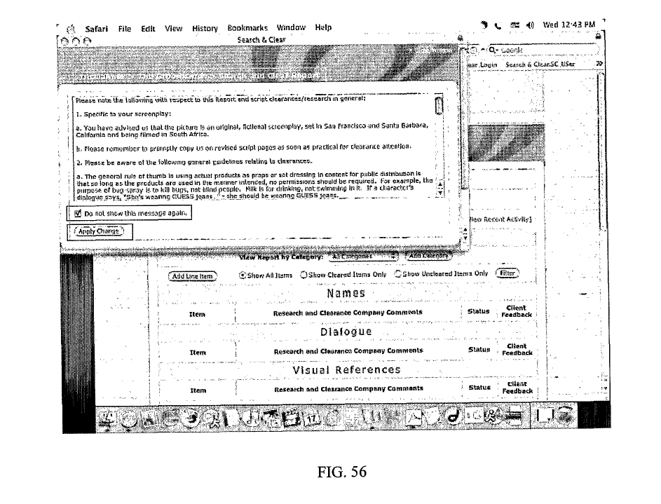

Additionally, when the Search and Clear Report page appears a pop up window is also generated containing the disclaimer. In the preferred embodiment, this pop up window will appear each time the Search and Clear Report page is selected unless the user selects the box adjacent to the message “do not show this message again”. See FIG. 56. As is known to those skilled in the art, the process for precluding future showings of the popup window can be carried out in many ways.

Following clearing of the pop up window, the RC administrator reviews the report to determine that all default categories appear on the report page. As indicated on the report page, the RC administrator does not need to return to the Set-Up Template page to add new categories to the report. Rather, the RC administrator has the ability to add categories from this page by selecting the “add category button”. If this button is selected, the RC administrator will automatically be returned to the Set-Up Template page and the setup template. Once on this page the RC administrator will typically click on the “Add a Category” button to add an additional category. In the example shown in FIG. 27, the new category “period cars” has been added in the text box associated with the “Add a Category” button. Once the button has been selected, this new category will be added to the report template. Additionally, as noted at the bottom of the category section on FIG. 27, the RC administrator has the ability to select the preferred order of categories within the report template by selecting the “Change Category Order” button.

Once the categories have been set, the RC administrator will typically return to the Reports page by selecting the “Reports” tab in the navigation bar or selecting the “Save & Go To Report” button or link at the bottom of the page. Once within the Reports page, the RC administrator needs to begin adding line items into the Search and Clear Report. Typically, the addition of line items will take place while the report is in the default view of “all categories”. Selecting the “Add Line Item” button will refresh the page with the add/edit line item as depicted for example in FIG. 28. In the example of FIG. 28, the item name is Jay Downy, a character to appear within the production of The Groomsmen. Since this is a character name, the drop down window associated with the category has been selected to reflect the Names category. Additionally, if necessary the RC administrator has the ability to return to the Set-Up Template page by clicking on the “Add a Category” button in order to further modify the template.

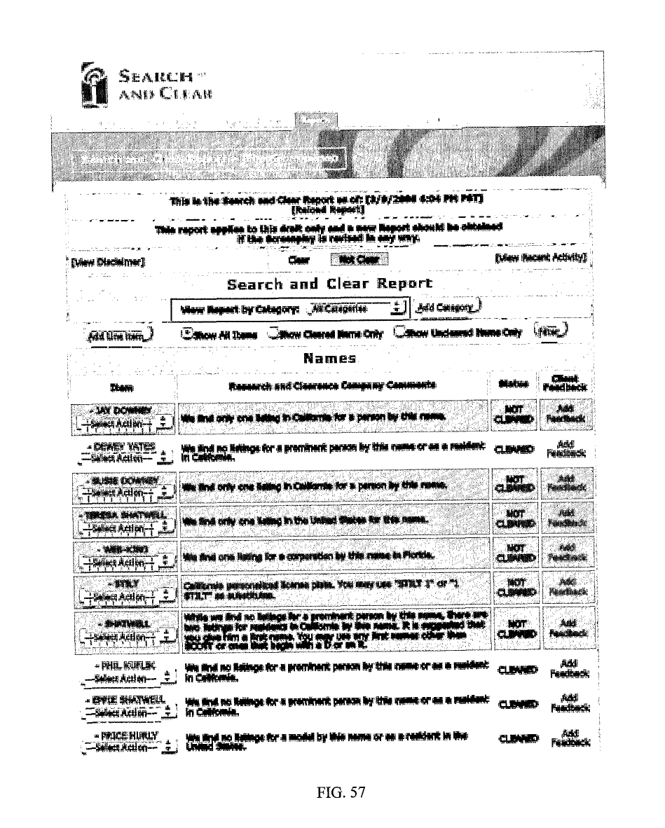

When populating the item portion of the report, the Add Edit Line Item page, depicted in FIG. 28 allows the RC administrator to add assets to the platform from his desktop or other electronic files. This is accomplished by selecting the “Choose File” button next to the term Asset. Typically these assets are electronic files such as mpegs, gifs, and jpegs etc. which provide additional information related to the item name. Since this particular item is a character name, no assets will be added to the platform at this time. Finally, the Comments box allows the RC administrator to enter currently available information related to this item. In the example of FIG. 28, the RC administrator is aware of one person living within California who also has this name. Since this item has not yet been cleared, the box associated with the phrase “Marked item as Cleared” is left unchecked. If no further changes are needed for this line item, the RC administrator clicks the “Save Line Item” button which stores the information within the platform for subsequent viewing by project team members. This process is repeated for each item to be added under each category. As items are cleared, the check box associated with the “Marked item as Cleared” will be checked and that item will be considered cleared for use in the production. An example of a report with numerous line items including cleared and uncleared items is provided in FIG. 57. As depicted in FIG. 57, items which are cleared are displayed differently from items which are not cleared.

At any time during the building of the template, the RC administrator may select the “Reports” tab in the navigation bar to confirm that the count of open items and cleared items is consistent with what has been entered. This step confirms that entries are being accepted by the platform in the proper manner.

Additionally, the Reports page provides multiple views allowing the RC administrator and other users to view the report in a manner most efficient for their current role. For example, the “View Disclaimer” link allows a user to confirm the disclaimer is present on the platform and includes the language necessary for the current project. Additionally, the “View Recent activity” link allows a user to view recent activity in the progress of the report. An example of a recent activity window is depicted in FIG. 29.

In the preferred embodiment, the recent activity is listed from the most recent to the earliest activity. The type of activity is indicated under the activity column which notes that it is a search and clear report and that a line item has been added in this instance. Further, under the Item column, the name of the item is provided preferably along with the initials of the user who entered the item. Finally, the date and time of the entry is indicated in the first column. In the preferred embodiment, the recent activity page may be modified by deleting earlier items through selection of the box associated with each item and clicking on an update or remove button. As previously noted, the terminology for each button may differ from platform to platform depending upon the preferences of the companies using the system. Further, those skilled in the art recognize that website design may take a variety of patterns.

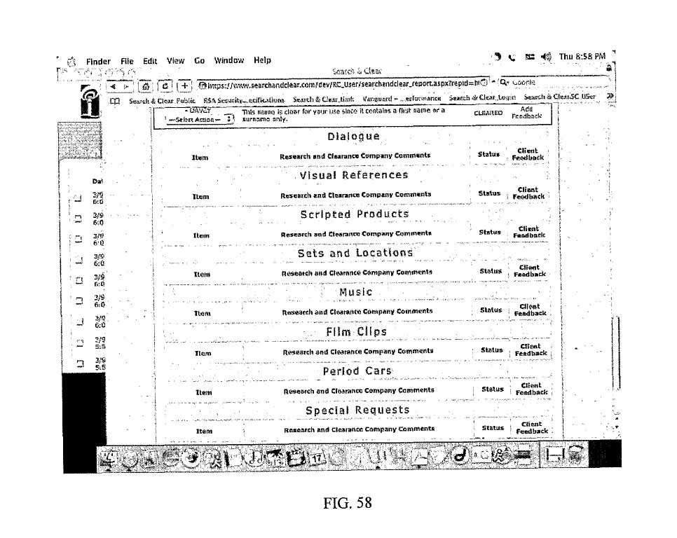

The recent activity page also provides links to the report. Thus, clicking on the name Davey as shown in FIG. 29 will take the user to the Search and Clear Report page. In this instance, the item linked will preferably appear at the top of the viewable portion of the webpage. See FIG. 58.

In addition to the Recent Activity link on the reports page, the user is provided with a Recent Activity link on the RC homepage. Thus, as previously noted the system provides multiple pathways to several components of the report and documents contained within the system.

The RC administrator continues adding line items to the report until each category has been populated with the items requiring research and clearance. As shown in FIGS. 26 and 57, the report provides for viewing of the line items based on whether the items have been cleared or not cleared and/or by category. Views by category are achieved by selecting the drop down window associated with the “View Report by Category” phrase. Beneath the drop down window are three buttons which determine the items to be displayed. The user preferably selects the desired view button and subsequently selects the “Filter” button to display the preferred choice. The color coded “Clear” and “Not Clear” tabs above the Search and Clear Report banner line are provided as a reminder to the user indicating the background for items which are cleared or not cleared.

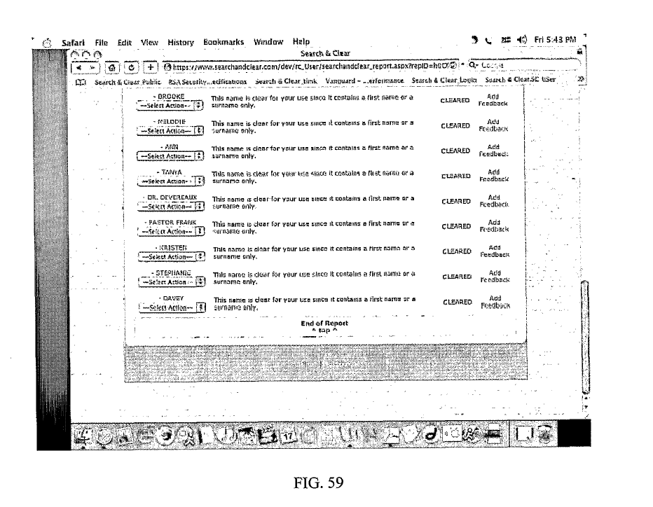

When the RC administrator has completed the process of building the template and reviewing the line items for accuracy, he may continue work on the search and clear process or may log out of the system. In this instance, the “Logout” button or link is provided at the end of the Search and Clear Report; however, the button or link may be placed at any appropriate location. See FIG. 59.

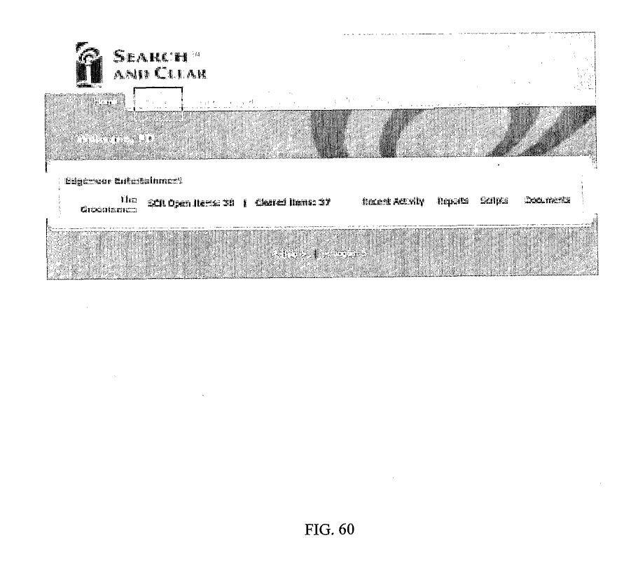

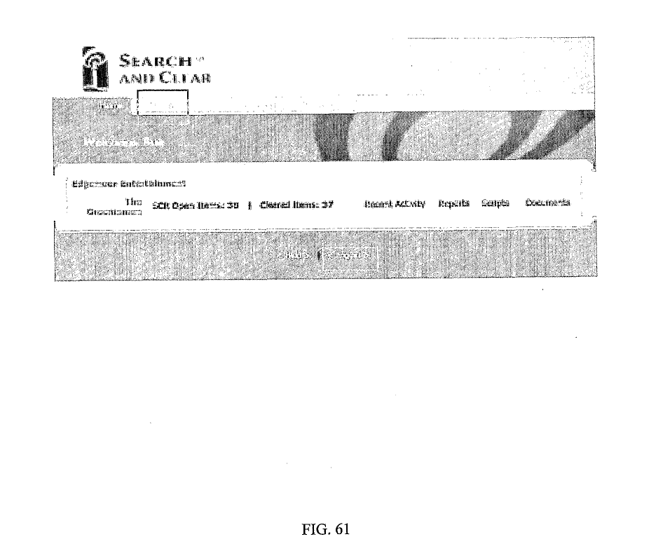

Each of the other team members assigned by the RC administrator will have access to the platform by entering their username and password on the log in page. In the preferred embodiment, when a user logs into the platform, the platform will recognize the user with a welcome page similar to that depicted in FIG. 21. Preferably, each user will have the same interface and functions as the RC administrator with the limitations set by the rights and permissions granted to the additional users. For example, if the new team members do not have the permission create additional team members then the “Users Admin” tab will be missing from their homepage and will be replaced with a “Users” tab. The “Users” tab will allow the additional team members to view but not add additional members or edit data for existing members. In this instance, the head researcher will have a home page wherein the “Users” tab has replaced the “Users Admin” tab. For example, see FIG. 60. Similarly, the remaining user has been identified as a researcher but has not been granted the right to build report templates. Therefore, their homepage will have the “Users Admin” tab replaced with a “Users” tab and the “Report Admin” tab has been omitted. See FIG. 61.

In the preferred embodiment, the RC administrator's tasks are carried out prior to the client accessing the platform. Thus, at this time it would be preferable for the client to now access the platform and review the set up and status of the report. Accordingly, one of the RC team members having the appropriate rights and permissions will preferably log onto the platform and select the “All Project Members” link. Selecting the “Edgemoor Entertainment” link in the pull down window associated with the “select client” will provide the user with access to the project team members. Since the platform administrator is required to enter the e-mail address for each of the team members assigned to the project, the RC team member will have access to the e-mail address for the client administrator. When the RC team member selects the e-mail address for the client administrator, the platform will preferably open a window containing an e-mail which the RC team member may complete and send to the project client administrator. Thereby notifying the project client administrator that the report is ready for viewing.

When the client administrator receives the e-mail from the RC team member, the client administrator will preferably access the platform by providing a user name and password. If the username and password are accepted, the client administrator will be taken to the client admin homepage where a greeting will be displayed including the client administrator's name. As depicted in FIG. 31, this homepage identifies the project, provides the number of open items and number of cleared items, and provides links to recent activity, reports, scripts and documents. Further, the homepage has a navigation bar similar to that found in the platform administrator and RC administrator homepages.

Typically, the client administrator will want to confirm the current client team member with access the project. Selecting the “User Admin” tab from the navigation bar, the client administrator is provided access to the user administration page which allows for adding and editing team members. This page includes a link entitled “All Project Members” which provides access to a subsequent page allowing for viewing of project members on a per project basis. Since no additional users have been added to the project client team, viewing All Project Members for The Groomsmen would indicate only the client administrator as a user. If the client administrator prefers, he may view his data on the Project Members' page to confirm that it is accurate. Otherwise, additional team members may be added using the format found in FIG. 32. As team members are added by the client administrator, they are granted rights to read or read with feedback and/or add/edit users as indicated on FIG. 32 by the appropriate checkboxes. Once all of the relevant data has been entered in the text boxes including identifying the role of the new team member and providing a username and password and indicating whether the team member will be an active or inactive member, then the client administrator selects the “Save User” button to add the new team member to the platform. Following addition of a team member, the client administrator will typically view the all project members to confirm that the entry has been accepted and is correct. Thus, as depicted in FIG. 33 the project administrator selects The Groomsmen and is provided with a web screen similar to that depicted in FIG. 34. Following confirmation, the project administrator selects the “User Admin” link to return to the Add/Edit Team Members page. The client administration continues this process until all team members have been added. As was the case in the research and clearance module, the client administration selects the rights and permission assigned to each team member.

Since the scrip is an essential component of the research and clearance process, the client administrator will typically confirm that the script has been properly uploaded to the platform and is available for viewing. The script is accessible through two methods in the client module. The first method is by clicking on the “Scripts” tab in the navigation bar. The second method is by accessing the Client homepage and selecting the “Scripts” tab associated with the project The Groomsmen. Either route will provide the client team members with access to the Scripts page similar to that depicted in FIG. 38. If the client is involved with more than one project, the drop down window will allow for toggling between the various projects. As shown in FIG. 38, the preferred embodiment includes a date and time associated with the uploading of the script. By clicking on the script link provided, typically displayed as the name of the script, the version and the extension identifying the format of the script, the module will open a new window displaying the script for viewing.

Upon confirmation that the script is available, the client admin will typically wish to view the Search and Clear Report next. Access to the report is also provided through two routes. As shown in FIG. 31, the “Reports” link associated with the project The Groomsmen will take the user to the report. Additionally, the navigation bar present on each web page also includes a “Report” tab which will open a page similar to that shown in FIG. 39 including a project pull down window which allows the user to select the project of interest.

Once the project has been selected, the initial page will appear in a manner similar to that depicted in FIG. 40, including identification of the project, the report type, the date and time that the report is being displayed, and a status field indicating the number of open items and the number of cleared items. Thus, this page provides a quick thumbnail view of the status of the search and clear report for the associated project. To access the actual report, the client administrator selects the “Search and Clear Report” link which refreshes the window with the “Search and Clear Report” for the project. However, the report appears initially behind a pop up window containing the disclaimer entered by the RC administrator. Unless the project administrator or subsequent project user selects the box next to the phrase “Do not show this message again”, this disclaimer will appear every time the report is viewed.

Clearing the screen of the disclaimer, the client administrator now sees the search and clear report as populated by the RC administrator. The Client Admin version of the search and clear report has the same functions as the RC admin version except for two functions: 1) the client admin version cannot “add/edit line items”, and 2) the client admin version does not have the “notes” function in the item pull down menu. The notes function will be discussed below.

As shown in FIG. 42, the report allows the client user to view the report in a variety of ways. If the user wishes to view only the cleared items in all categories, the user selects the button associated with “Show Cleared Items Only” and clicks on the filter button. Typically however, the client user will be more concerned with the items which have not been cleared. Selecting only the uncleared items is accomplished in the same manner by selecting the button associated with the “Show Uncleared Items Only and clicking on the “Filter” button. If the show all items is selected, the preferred embodiment of the search and clear report will display cleared and uncleared items with contrasting backgrounds. In one preferred embodiment, cleared items are depicted with a white background while uncleared items are depicted against a blue/gray background. A reminder of the distinction is provided above the “Search and Clear Report” banner by the contrasting “Clear” and “Not Clear” tags.

Provided that the client user has the appropriate rights and permissions, the user has the ability to add feedback for each of the items under the categories. For example, if the user has comments or questions concerning the first line item relating to the character “Jay Downey”, the user will select the add feedback link associated with that item. This action will take the user to a new webpage similar to that depicted in FIG. 44. This view feedback webpage indicates that there is currently no feedback for this item and instructs the user to click the “Add Feedback” button to begin a thread of feedback associated with this item. Selecting the add feedback will open a new window similar to that depicted in FIG. 45 which provides a subject line and text box thereby allowing the user to enter the nature of the comment and a detailed discussion concerning the item. This feedback mechanism enhances the cooperation and communication between the research and clearance company and the client thereby improving the overall research and clearance process and creating a file history for each item.

Following entry of the comments by the client user, the client user selects the “submit” button which refreshes the window with the View Feedback page associated with the line item. This page indicates the source of the comment as well as the date and time the comment was entered. A quick return to the report is enabled by the “Back to Report” button on this page. By selecting this button, the client user returns to the Report page and notes that the line item Jay Downey has changed in that the far right column has been altered from Add Feedback to View Feedback. In the preferred embodiment of the method of using the platform, the client user continues to review each line item which has been uncleared or cleared and add feedback as necessary.

The other team members may access the platform at any time in a manner similar to that of the client administrator. Thus, their access is gained by accessing the log on page, entering a username and a password and selecting submit. Provided that the username and password are accepted they will be taken to their own homepage which displays a greeting including their name. The functions available to each client user on their homepage will be determined by the rights and permissions granted to them by the client administrator.

As noted in the discussion concerning the platform, if the client user has read with feedback permission, any new feedback which has been previously entered by a project team member will have the term “New Feedback” displayed in the Client Feedback column. Preferably this terminology will be highlighted in a manner designed to draw attention to the column. Additionally, the link on the reports page which previously read “View Recent Activity” will preferably be changed to display “New Feedback”. Thus, if a user accessed the page after the client administrator entered a comment for the character Jay Downey, and that user had read with feedback rights, the view recent activity link will have been changed to “New Feedback”. Additionally, the view feedback link associated with the line item will be highlighted and converted to read “New Feedback”. Once this link has been selected and the comments viewed it will revert to “View Feedback”.

When viewing recent activity through the reports page, following selection of the “Recent Activity” link or if it has changed to the “New Feedback” link, the user will see a pop up window displaying line items having recent activity. In the preferred embodiment, the date and time of the activity is indicated along with the item and the activity which has occurred. Further, the initials of the user generating the recent activity are displayed. In the preferred embodiment the recent activity is displayed with the most recently affective item at that the top. As in the RC module, if the user has the appropriate permission, they may delete items from the recent activity page by selecting the check box next to the item and clicking on the appropriate button.

Further, as in the RC admin module selecting the name of the item will return the user to the report page. Preferably, the page will be displayed on the monitor for viewing by the user with that item at the top of the report window.

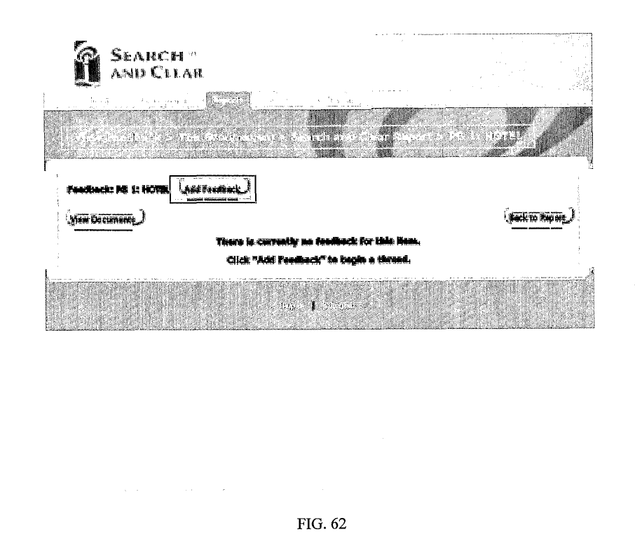

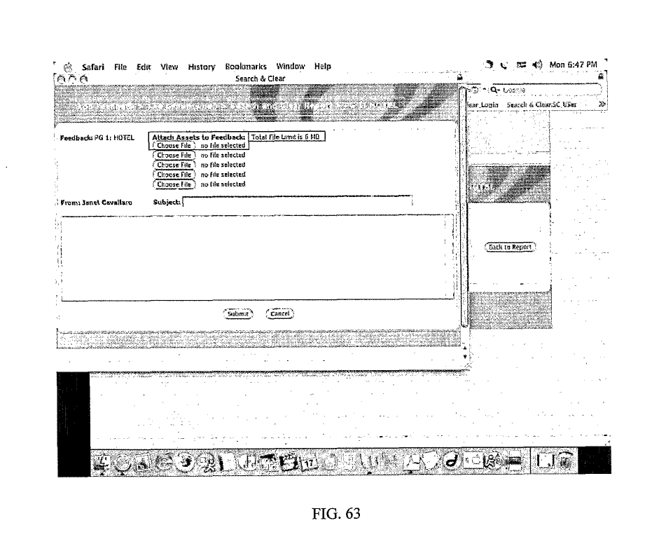

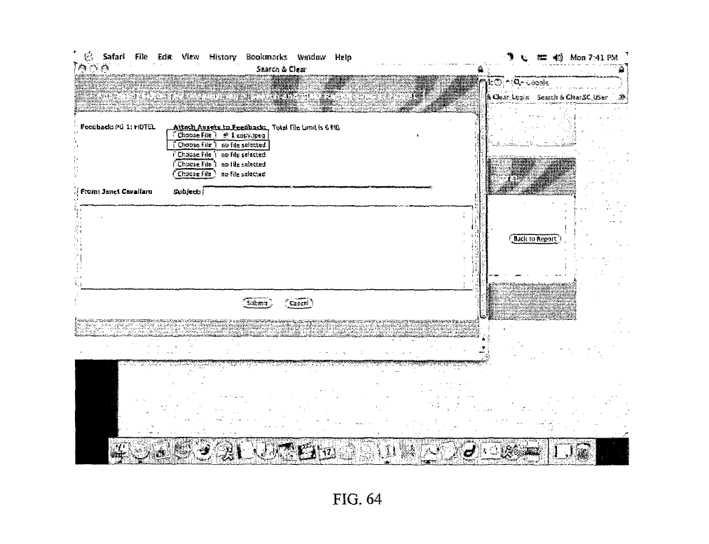

In the preferred method, the client user will typically view the report in the Not Cleared item mode. Once this mode has been selected, the user continues to view new feedback associated with each item. This information provides the user with the ability to aid in the ongoing research and clearance process. Further, if the user has feedback rights, they may enter additional information into the thread started by the RC team member. The process of adding feedback corresponds to that discussed above with regard to the RC team. For example, the client team member may wish to add comments to the line item “PG 1: Hotel”. See FIG. 62. By selecting the add feedback button a pop up window appears allowing the user to provide feedback in the text box as well as the ability to attach assets to the feedback. In this instance, the total memory allocated to the assets is six megabytes. However, this may vary depending on the system running the platform. The client user selects the top “choose file” button and then selects the desired file from their computer system or other storage medium. Following selection of the file, the “Add Feedback” page appears reflecting the addition of the asset. (See FIGS. 63 and 64). Additional files are added as necessary using this step.

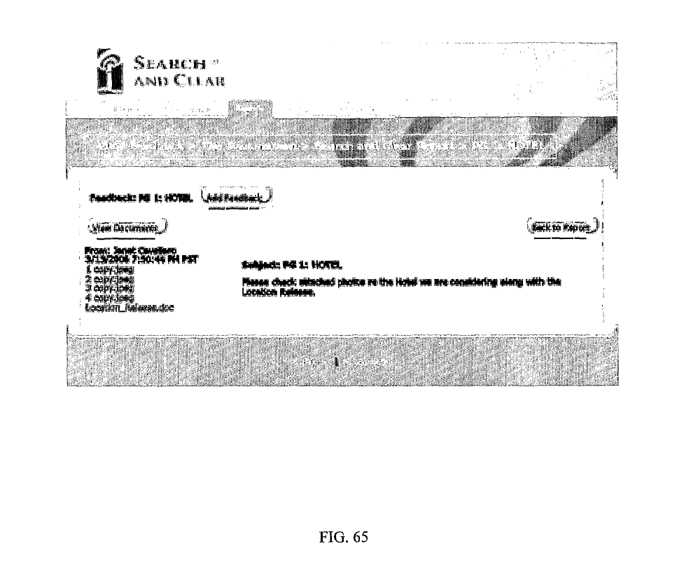

Following entry of the desired comments in the text box, the user clicks the “Submit” button which refreshes the window with the “View Feedback” page depicted in FIG. 65. This page displays the comments and indicates the files added to the system. If the user wishes to confirm that the files have indeed been downloaded to the platform, they may select the “View Documents” button which refreshes the screen with the Documents page. As shown in FIG. 50, each of these documents is available for viewing and the date and time of positing the documents is provided. In the preferred embodiment clicking on the link associated with the document will open the document in a new window.

Users may also view files attached to a line item by selecting the “Item” pull down menu and then selecting “View Documents”. This process will bring up the Documents window once again.

As previously indicated, documents added by either RC users or client users are preferably stored in a central archive.

In the preferred embodiment, each of the users for the client will log onto the platform, provide their username and password and review the report providing feedback and comments as determined by the rights and permissions. If a user for the client does not have the ability to add/edit team members, their navigation bar will differ from the client administration navigation bar by replacement of the “Users Admin” button or tab with a “User's” tab. In this manner, the user may still view team members and users associated with a client, but will not be able to add additional members or edit data for existing members. Finally, if a user does not have “Read with Feedback” permission, the “Client Feedback” column will be omitted from the report. For these users access to the feedback provided by other team members will be determined as desired by the client.

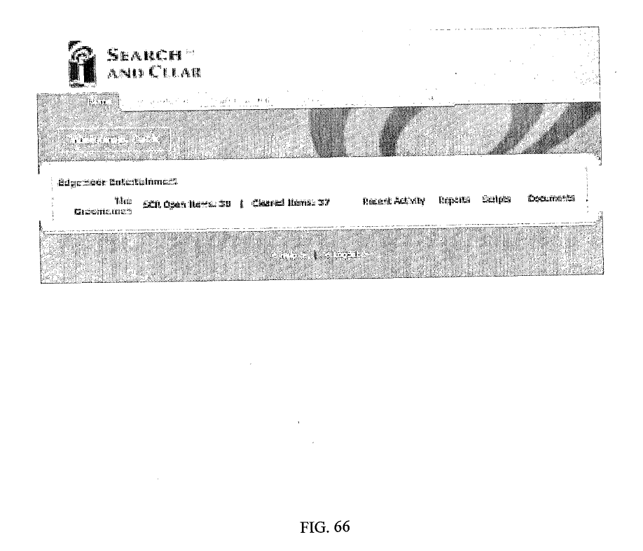

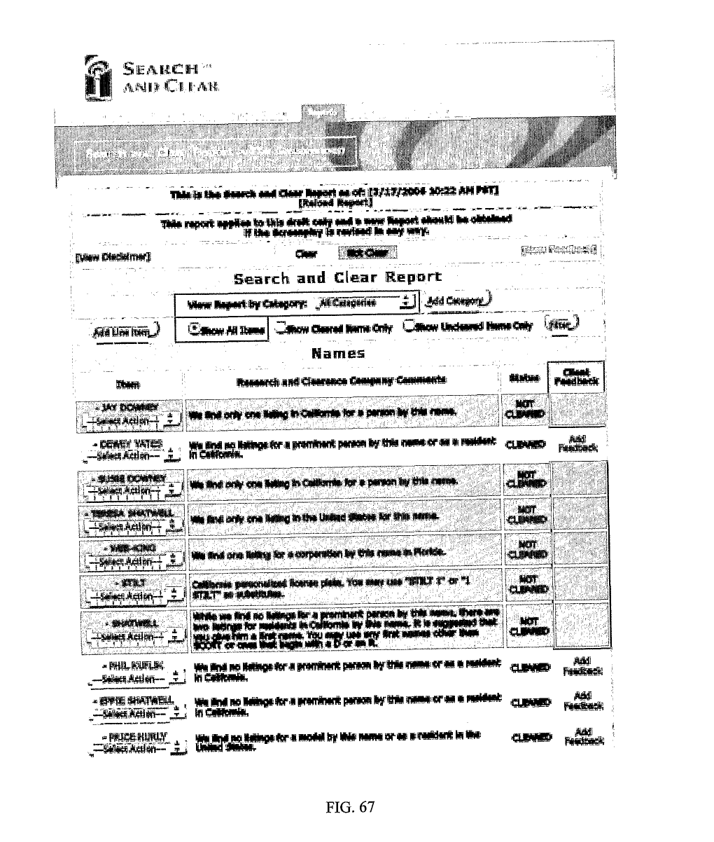

Following the initial entries by the Research and Clearance Team members and the Client Team members, the Research and Clearance Team members will need to log back into the platform to view comments and information provided by the Client Team members. Assuming for this example that the RC administrator logs back into the platform, upon successfully entering the username and password, Jack Smith will be taken to his homepage as depicted in FIG. 66. The homepage now displayed indicates that thirty-eight items are considered to be open while thirty-seven items have been cleared for use in the project The Groomsmen. From the homepage, the RC administrator has the option of viewing either recent activity or the report in order to gain access to comments entered by project team members. Selecting the appropriate link will provide the RC administrator with the pages described above. Selecting the Report page takes the RC administrator to the Search and Clear Report for The Groomsmen. As depicted in FIG. 67, this page contains highlighting alerting the RC administrator to the presence of new feedback as provided by project team members associated with the client. Additionally in the default view of showing all items, the cleared items are depicted with a white background while the uncleared items are depicted with the blue/gray background. Further, the link which previously read View Recent Activity has been converted to “New Feedback” and the column entitled Client Feedback indicates several entries contain “New Feedback”.

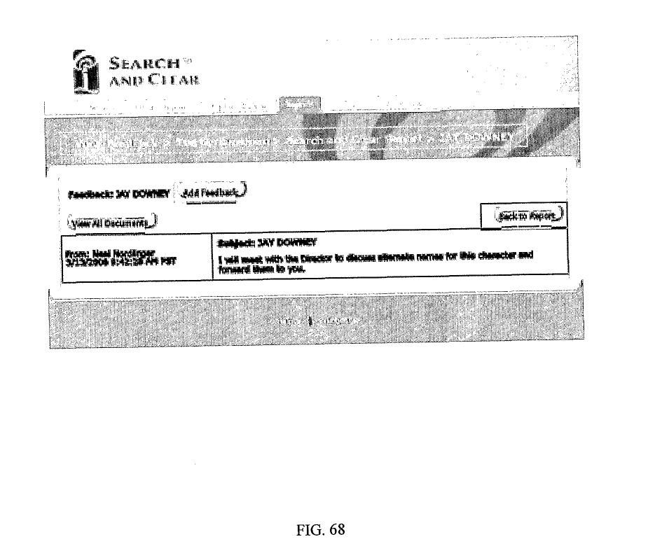

In the preferred method of using the platform, the RC administrator will select the button for “Show Uncleared Items Only” and click on the “Filter” button to refresh the window with all categories view of the Search and Clear Report while displaying only those items which have not been cleared. By way of example, the RC administrator selects the “New Feedback” link in the “Client Feedback” column associated with the line item “Jay Downey.” Selection of this link displays the View Feedback page depicted in FIG. 68. This page provides the RC administrator with the option of responding to this feedback by clicking the “Add Feedback” tab or button or the RC administrator may edit this line item by returning to the report through selecting the “Back to Report” button and using the “Client Feedback” colunm link. In the preferred embodiment the audit trail will be easier to follow for a particular line item if the Client Team Members enter their comments and questions via the “Client Feedback” column and the RC Team Members enter their responses and findings via the line item fields.

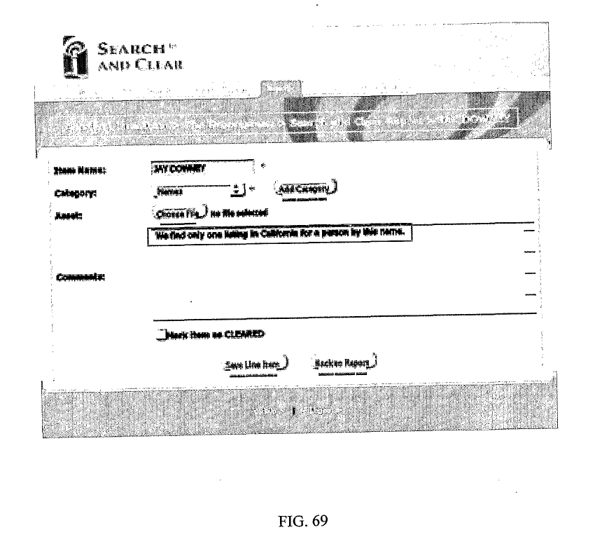

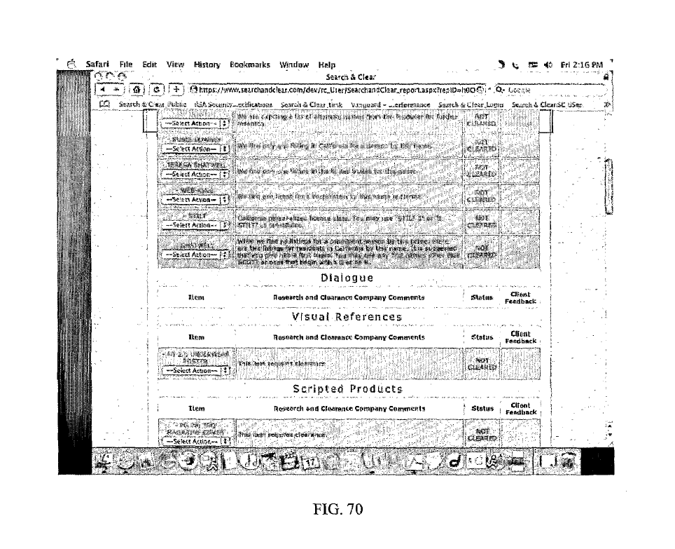

Thus, on return to the Search and Clear Report, the RC administrator selects the Item name (JAY DOWNEY) which is a link to the Add/Edit Line Item. This action refreshes the window with the “Add/Edit Line Item” page as depicted in FIG. 69. After considering the feedback provided by the client project team member, the RC administrator deletes the comment appearing in the comments field and enters a new comment stating “we are expecting a list of alternate names from producer for further research”. Since the item has not yet been cleared the box next to the “Mark Item as CLEARED” remains unchecked. Subsequently, the RC administrator clicks on the “Save Line Item” button which refreshes the window with the Search and Clear Report. In the refreshed window, the Jay Downey line item is at the top of the page as context is preferably maintained between the Add/Edit “Line Item” page and the refreshed “Report” page. Finally, the “New Feedback” link in the Client Feedback column now reads “View Feedback”.

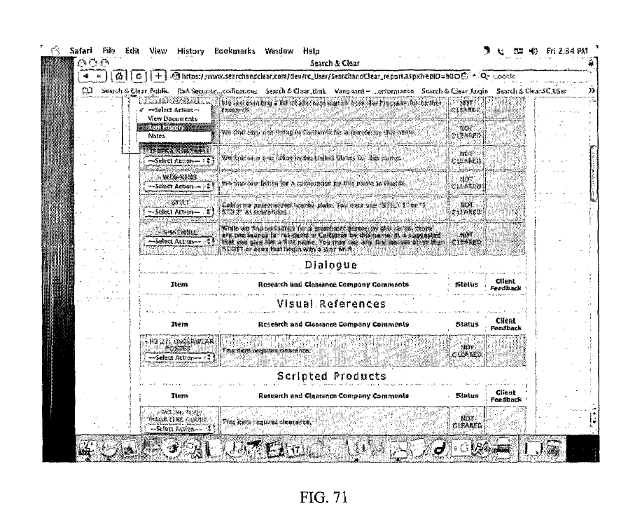

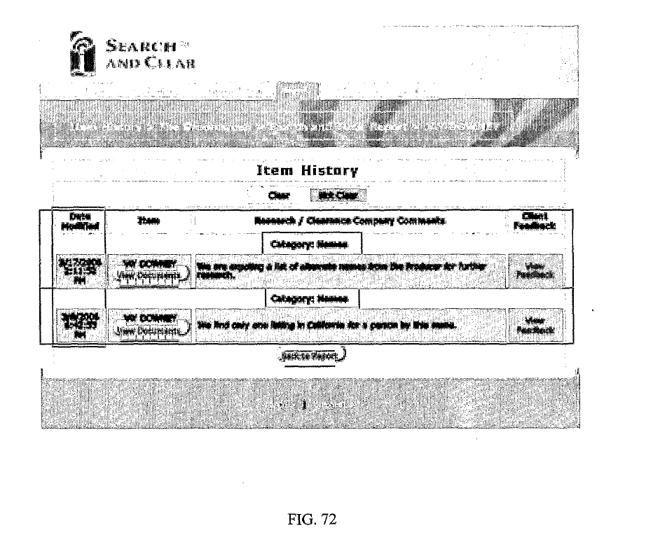

To confirm that an audit trail has been created, the RC administrator utilizes the pull down window associated with the Jay Downey line item and selects Item History as depicted in FIG. 71. This action refreshes the window with the “Item History” page and confirms that the prior comment entered by the RC administrator has been stored along with the new comment. See FIG. 72. In the preferred embodiment, the line item in the Item History retains the blue/gray background corresponding to an uncleared item. Additionally, the Item History page provides access to the view feedback associated with the item.

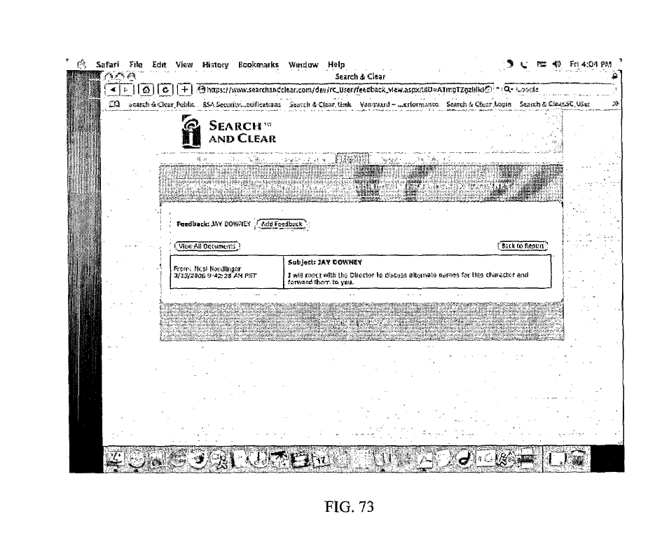

Selecting the View Feedback link for the upper line item provides the RC administrator with access to the View Feedback page as depicted in FIG. 73.

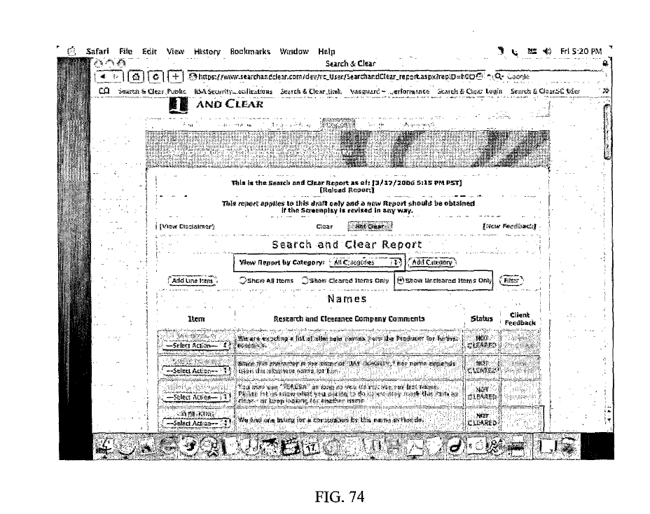

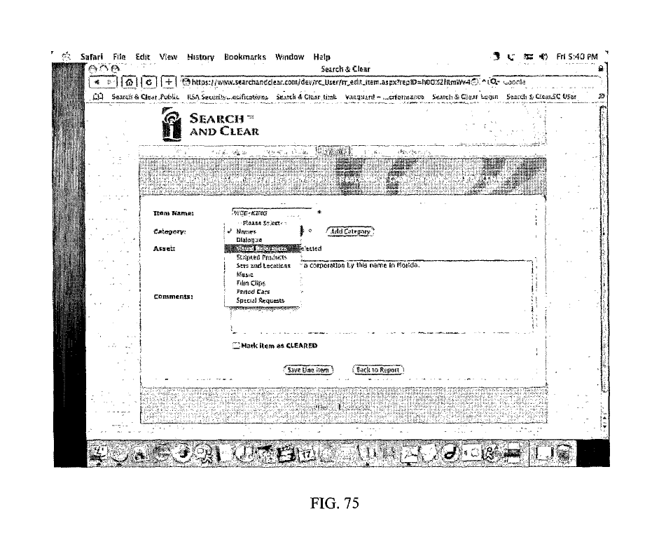

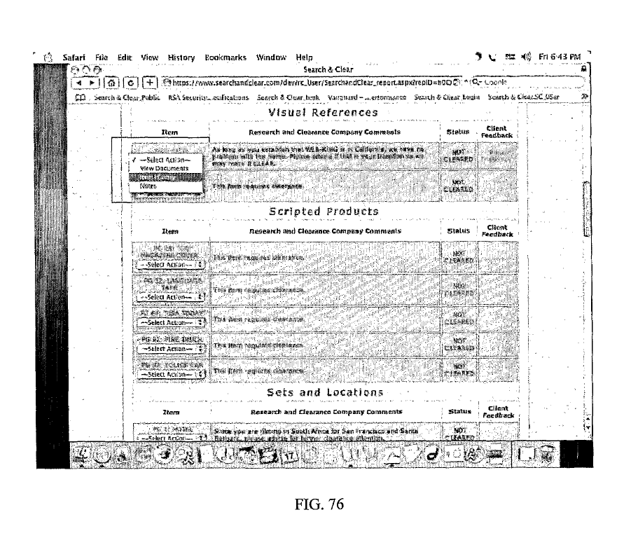

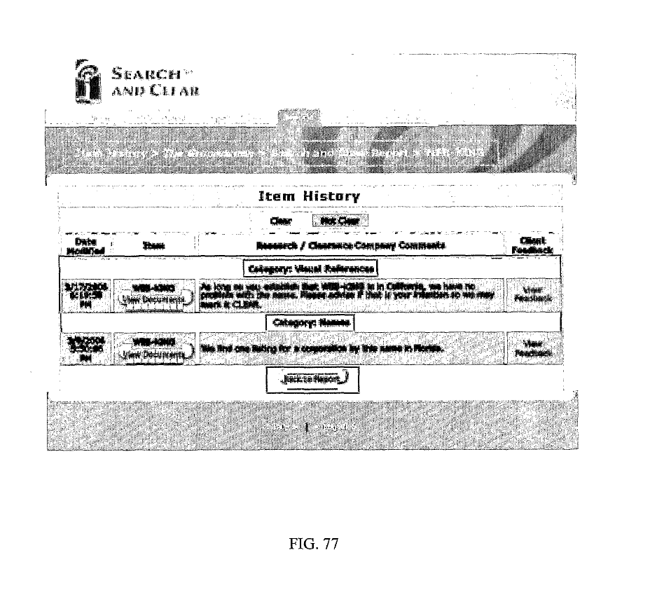

If at anytime the RC administrator determines that a line item has been improperly categorized, the RC administrator may move the line item to the correct category. For example, in FIG. 74, Web-King is listed under the Names category. However, the RC administrator has determined that Web-King should belong to the “Visual References” category. Therefore, to move the line item, the RC administrator clicks on the Web-King link which refreshes the window with the “Add/Edit Line Item” page previously used for entering the line item. To move the line item, the RC administrator utilizes the category pull down menu and selects visual references. See FIG. 75. Subsequently upon returning to the report page, Web-King is found under the Visual References category. To confirm that all elements within the item history for Web-King have also been moved along with the item, the RC administration selects the drop down menu under the Web-King line item and chooses “Item History” as depicted in FIG. 76. This action refreshes the screen with the Item History page confirming that entries made when Web-King was listed under category names remain associated with the line items. See FIG. 77.

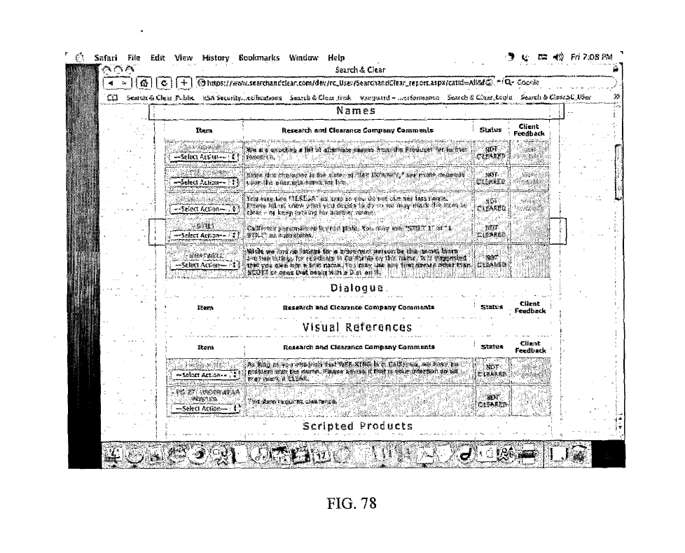

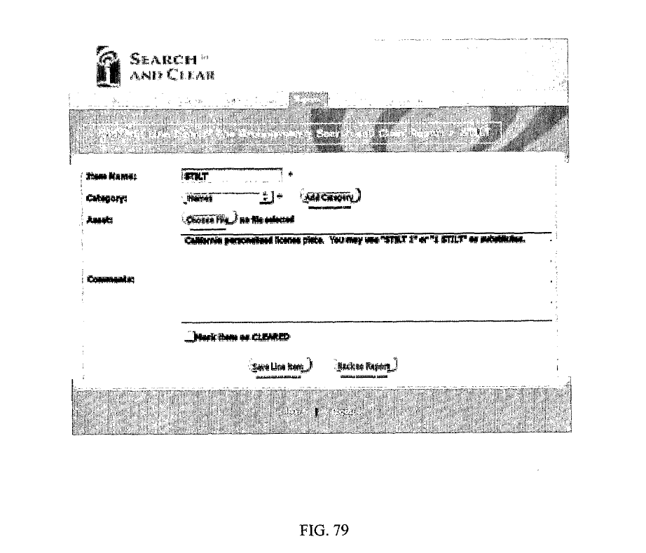

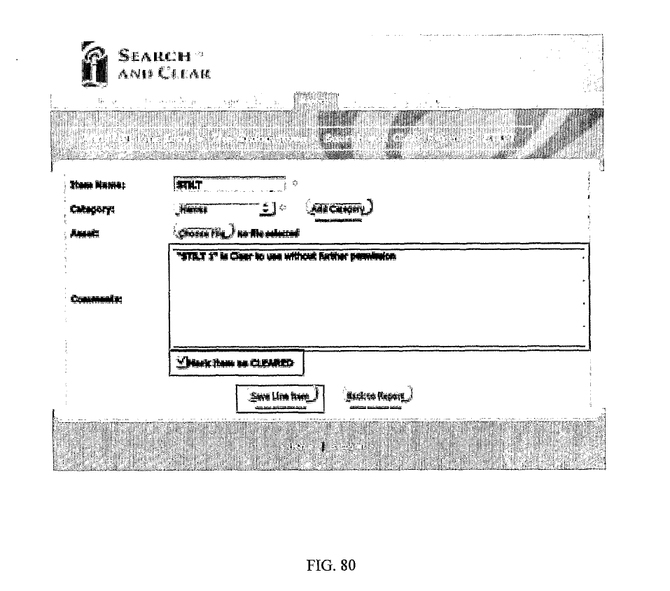

The RC administrator continues to view the report reading the feedback provided by the client. For example, selecting the new feedback link associated with the “stilt” item as shown in FIG. 78, the RC administrator learns that the client has elected to use “stilt 1”. Returning to the report, the RC administrator selects the “Stilt” link in the item column which brings up the Add/Edit Line Item page associated with Stilt as shown in FIG. 79. As discussed above, this is the preferred method for establishing an audit trail using the platform. The RC administrator deletes the comment appearing in the comment box and replaces it with a comment indicating “stilt 1 is clear to use without further permission”. Additionally, the RC administrator checks the box associated with “Mark Item as CLEARED” and clicks on “Save Line Item” button. This action refreshes the window with the report and the “Stilt” line item at the top of the window; however, the line has now changed to a white background and the text indicates that the line item is cleared. In the preferred embodiment, the refresh action defaults to the all categories view of show cleared items only.

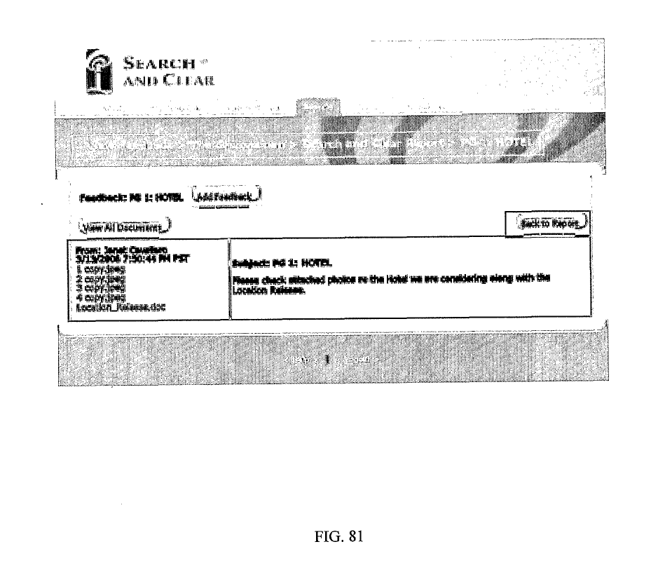

In general, the RC administrator will return to the display depicting only uncleared items and will continue viewing comments provided by the client and clearing items as appropriate. For example, the RC administrator will necessarily view the new feedback associated with the item PG 1: Hotel. Selecting the View Feedback button or link for this item refreshes the screen with the View Feedback page depicted in FIG. 81. This page provides the RC administrator with the ability to view each of the documents previously attached by the Client Team Member. Additionally, the RC administrator is informed of the date and time, the Client Team Member added the documents to the platform as well as the name of the Client Team Member. Additionally, the RC administrator notes that one document is a word document and downloads it to its desktop. This enables the RC administrator to make changes to the document and subsequently save it to the platform using a new name. As discussed above, this is accomplished by returning to the Report page and selecting the PG 1: Hotel link in the Item column thereby refreshing the window with the “Add/Edit Line Item” page for this item. Once in the add/edit line item page, the RC administrator has the ability to add further assets to the item and to make further comments as discussed above. Thus, in this particular instance, the RC administrator will add the revised document previously downloaded from the View Feedbacks window.

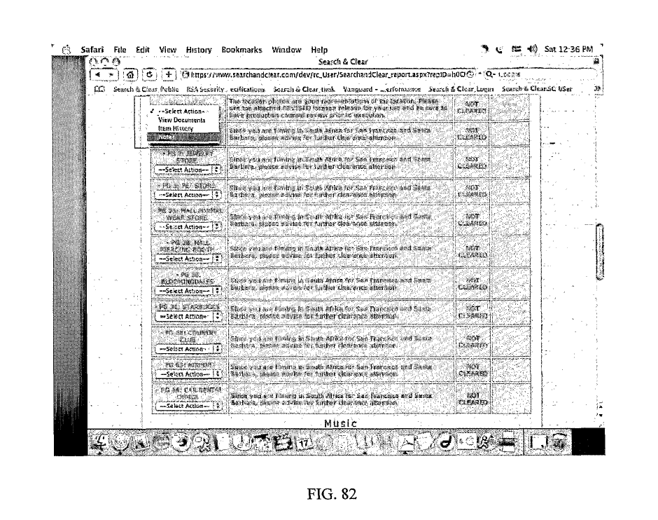

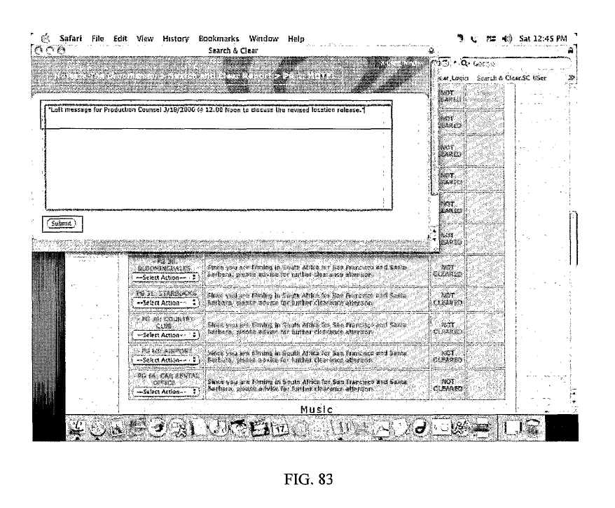

In order to keep track of daily activity related to each individual line item, the RC module allows the RC administrator to maintain a thread of “Notes” which are viewable only to RC team members. In the preferred embodiment, these notes are not posted or viewable by project team members associated with the client. With continued reference to the PG 1: Hotel line item, using the pull down menu, the RC administrator selects the notes link as shown in FIG. 82. In the preferred embodiment, this action brings up a new window which provides a text box as depicted in FIG. 83. As shown therein, the RC administrator has entered a note which indicates that a message had been left with production counsel. When the RC administration clicks the submit button, the window preferably closes leaving the search and clear report displayed with the PG: 1: Hotel line item at the top of the window. Thus, other RC Team Members will be advised as to the status of this line item without making this information available to Client Team Members.

The RC administrator may confirm that the note has been stored by once again selecting the “Notes” in the pull down menu and viewing the pop up window for the text just entered.

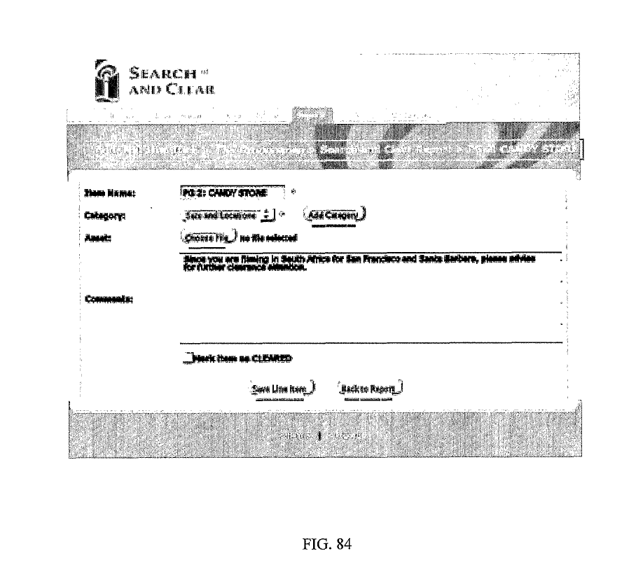

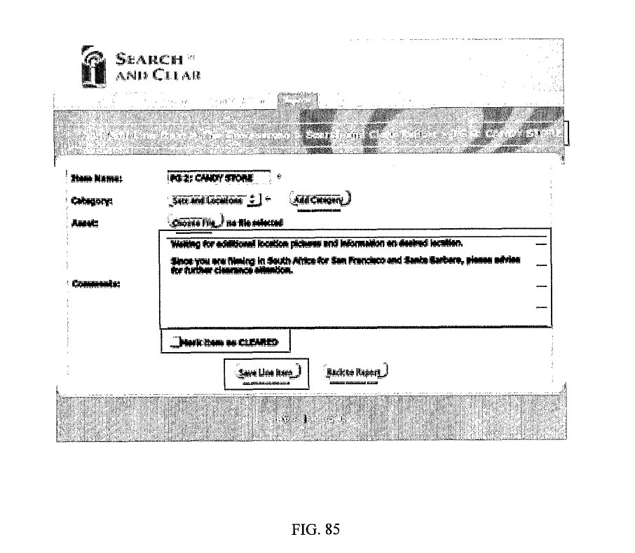

The RC administrator continues viewing line items and adding comments and creating notes as necessary to meet the needs of the research and clearance project. Comments entered by the RC administrator may be made in the manner discussed above wherein the previous comment is deleted and a new comment added using the Add/Edit Line Item page. However, occasionally the administrator may elect to retain the original comment while adding additional material to the comment box. For example, FIG. 84 depicts the original comment box for the line item PG 2: Candy Store. In this instance, the RC administrator wishes to add new text, but retain the prior text. Therefore, the administration accesses the Add/Edit Line Item page as discussed above, enters the comment box and simply returns a sufficient number of times to create space above the original comment and then adds new commentary. See FIG. 85.

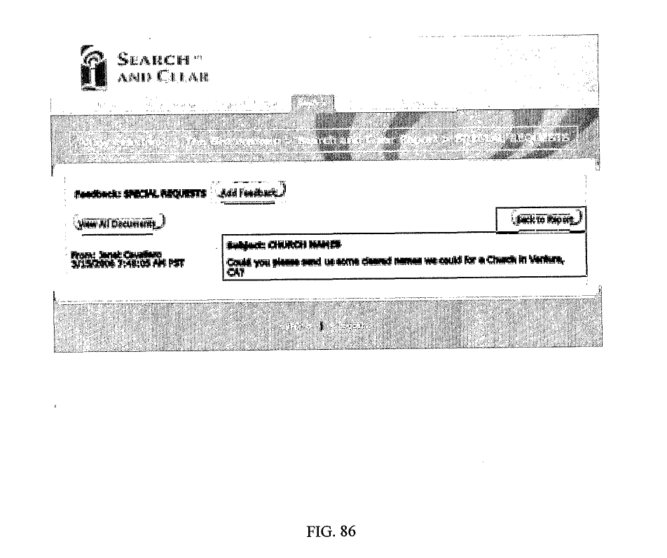

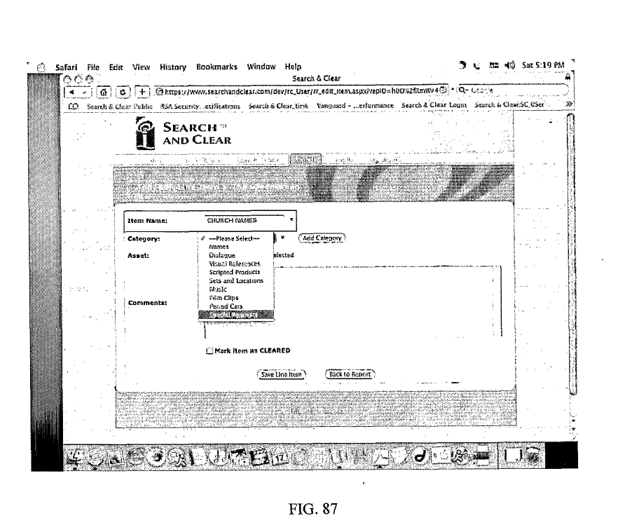

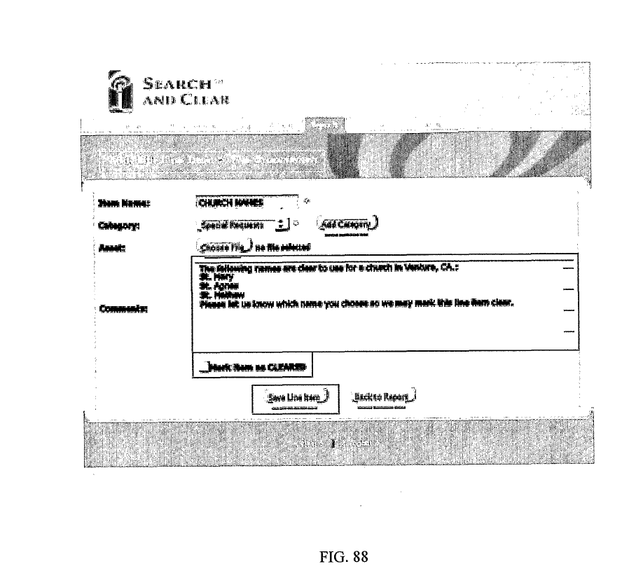

After completing the line items in the primary categories, the RC administrator views the “New Feedback” link for the special request line items in the “Special Requests category. This action takes the RC administrator to the View Feedback page associated with this category as depicted in FIG. 86. Since the special request related to a new item, the RC administrator returns to the Search and Clear Report and selects the “Add Line Item” button. As discussed above, this action will open or refresh the screen with the add/edit line item page. This allows the RC administrator to add the new line item associated with “Church Names” and associate the line item with the category special requests using the pull down menu. See FIG. 87. The RC administrator has the ability to subsequently add the appropriate text within the “Comments” box responding to the client's question. However, the check box next to the “Mark Item as CLEARED” line remains empty as the item has not yet been cleared. See FIG. 88. Following selection of the “Save Line Item” button, the screen refreshes with the Search and Clear Report. As refreshed, the report will display the item “Church Names” under the special request category and the text in the Client Feedback Column remains “Add Feedback” as no feedback has been added for this item yet.

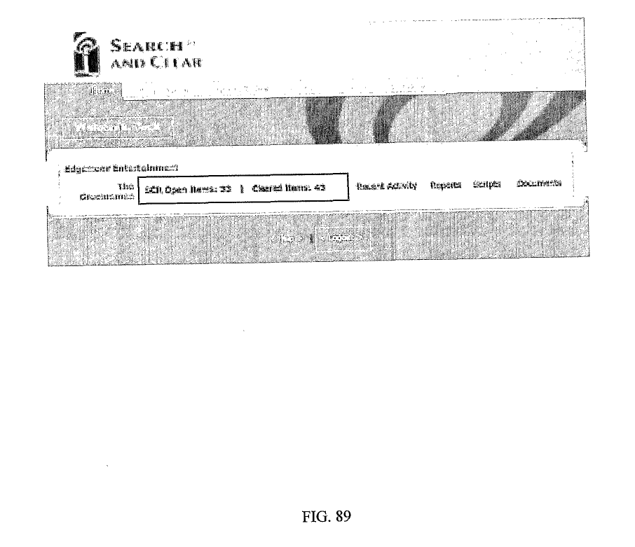

Since the RC administrator has completed review of the report, the RC administrator selects the home tab from the navigation bar thereby refreshing the screen with the Homepage. As shown in FIG. 89, the homepage indicates the updated totals for open items and cleared items as thirty-three open items and forty-three cleared items.

In the preferred embodiment, the RC administrator once again accesses the “Project Members” link and sends an e-mail to the client administrator advising of the update to the Report. Accordingly, the client once again will access the report repeating the process described above. The method subsequently cycles between review of the report by the client and the RC company until all line items have been cleared.

While the present invention has been described in detail with reference to the screen captures provided in the Figures and the foregoing example, other embodiments will be apparent to those skilled in the art. Therefore, the foregoing specification is considered exemplary with the true scope and spirit of the invention being indicated by the following claims.

I claim:

1. An interactive system for coordinating a research project between at least two parties comprising:
a platform administrator module;
a research and clearance module;
a client module;
a database suitable for storing data entered through said platform administrator module, said research and clearance module and said client module;
said platform administrator module provides the means for adding a project to said system;
said platform administrator module provides the means for adding a research entity to said system and for associating said research entity with at least one project on said system;
said platform administrator module provides the means for adding a client entity to said system and for associating said client entity with at least one project on said system.

2. The interactive system of claim 1, wherein said platform administrator module comprises data entry capabilities for providing access to said system to at least one individual associated with said research entity and for providing access to said system to at least one individual associated with said client entity.

3. The interactive system of claim 2, wherein said platform administrator module provides the means for assigning access rights to said interactive system for said individual associated with said research entity and for said individual associated with said client entity.

4. The interactive system of claim 3, wherein said research and clearance module provides the means for providing additional individuals associated with said research entity access to said system and assigning rights to said additional individuals.

5. The interactive system of claim 3, wherein said client module provides the means for providing additional individuals associated with said client entity access to said system and assigning rights to said additional individuals.

6. The interactive system of claim 1, wherein said platform administrator module provides access to projects stored within said system and for viewing said projects by selected classification of said projects.

7. The interactive system of claim 6, wherein said projects are classified as active or inactive and said platform administrator module provides views selected from the group of view all, view active only and view inactive only.

8. The interactive system of claim 7, wherein the system indicates the number of active and inactive projects regardless of the view selected.

9. The interactive system of claim 8, wherein said platform administrator module provides access to a list of all client entities stored within said system and for viewing said list of client entities by selected classification of said clients.

10. The interactive system of claim 9, wherein said platform administrator module provides access to a view of said client entities and the projects associated with said client entities.

11. The interactive system of claim 9, wherein said client entities are classified as active or inactive and said platform administrator module provides views selected from the group of view all, view active only and view inactive only.

12. The interactive system of claim 11, wherein said platform administrator module includes a homepage depicting at least the number of active and inactive projects, active and inactive clients and the number of individual logged into the system.

13. The interactive system of claim 11, wherein said platform administrator module provides access to a webpage depicting all client entities, all projects and all research entities stored within said database of said system.

14. The interactive system of claim 13, wherein said webpage comprises a drop down window or toggling link for selecting a view associated with currently active projects, currently inactive projects or all projects.

15. The interactive system of claim 1, wherein said research and clearance module comprises a homepage view depicting at least said projects associated with said research entity.

16. The interactive system of claim 15, wherein said homepage view comprises a navigation bar, said navigation bar providing said individual associated with said research entity access to the interactive system through said research and clearance module.

17. The interactive system of claim 16, wherein said navigation bar provides said individual associated with said research entity with the means for associating additional individuals with said research entity and granting said individuals with rights to access said interactive system through said research and clearance module.

18. The interactive system of claim 15, wherein said homepage view further provides direct access to elements of each project associated with said research entity.

19. The interactive system of claim 18, wherein said direct access includes access to recent activity relating to said project and stored within said database.

20. The interactive system of claim 18, wherein said direct access includes access to documents relating to said project and stored within said database.

21. The interactive system of claim 2, wherein said research and clearance module provides said individual associated with said research entity access to data relating to each individual associated with said research entity.

22. The interactive system of claim 2, wherein said research and clearance module provides said individual associated with said research entity access to data relating to each individual associated with said client entity.

23. The interactive system of claim 16, wherein said navigation bar provides said individual associated with said research entity with access to a report template.

24. The interactive system of claim 23, wherein said report template includes the means for entering a disclaimer to be associated with a report generated from said report template and associated with a project.

25. The interactive system of claim 23, wherein said report template includes a predetermined list of categories.

26. The interactive system of claim 25, wherein said report template provides the means for adding additional categories to a report based on said report template.

27. The interactive system of claim 23, wherein a report based on said report template displays each selected category, and wherein said report provides the means for adding items associated with each category to said report.

28. The interactive system of claim 27, wherein the research status for each item listed in said report is indicated.

29. The interactive system of claim 28, wherein the research status for each item listed in said report is indicated by a visually contrasting background.

30. The interactive system of claim 28, wherein the research status for each item listed in said report is indicated by a text note.

31. The interactive system of claim 27, wherein said means for adding a line item further provides the means for associating comments relating to said item.

32. The interactive system of claim 31, wherein said comments associated with said item are displayed as part of said report.

33. The interactive system of claim 2, wherein said client module comprises a homepage view depicting at least said projects associated with said client.

34. The interactive system of claim 33, wherein said homepage view further depicts the number of items associated with said project and provides access to documents associated with said project and to at least a report describing the status of said project, wherein said report is a component of said system accessible by both said client module and said research and clearance module.

35. The interactive system of claim 34, wherein said homepage view further provides direct access to elements of each project associated with said client entity.

36. The interactive system of claim 33, wherein said homepage view comprises a navigation bar, said navigation bar providing said individual associated with said client entity access to the interactive system through said client module.

37. The interactive system of claim 36, wherein said navigation bar provides said individual with access to at least one report generated by said research entity associated with said project and to documents associated with said project.

38. The interactive system of claim 36, wherein said navigation bar provides said individual associated with said client entity with the means for associating additional individuals with said client entity and granting said individuals with rights to access said interactive system through said client module.

39. The interactive system of claim 38, wherein said means for adding additional individuals to said client module is accessed through a link or tab on said navigation bar and wherein said means for adding additional individuals is a webpage suitable for entering data relating to said individual and for assigning said additional individuals access rights to said client module.

40. The interactive system of claim 38, wherein said navigation bar is tailored to the access rights of said additional individuals.

41. The interactive system of claim 38, wherein said means for adding additional individuals to said client module further provides the means for classifying the role of said additional individual in said project.

42. The interactive system of claim 34, wherein said client module automatically displays a disclaimer when a report is accessed through said client module.

43. The interactive system of claim 34, wherein said client module automatically displays a disclaimer in a new window when a report is accessed and said report is at least partially visible behind said disclaimer.

44. The interactive system of claim 34, wherein when said report is displayed, the research status for each item listed in said report is indicated by a visually contrasting background.

45. The interactive system of claim 34, wherein said client module permits entry of data by said individuals associated with said client module on said report and wherein said data entered by said individuals associate with said client module is accessible by said individuals associated with said research and clearance module.

46. The interactive system of claim 2, wherein said client module provides said individual associated with said client entity access to data relating to each individual associated with said research entity.

47. The interactive system of claim 2, wherein said client module provides said individual associated with said client entity access to data relating to each individual associated with said client entity.

48. The interactive system of claim 35, wherein said direct access includes access to recent activity relating to said project and stored within said database.

49. The interactive system of claim 34, wherein said report includes access to recent activity relating to said project and stored within said database.

50. The interactive system of claim 34, wherein said report includes line items arranged by category and wherein said report provides access to a history of research associated with each line item.

51. The interactive system of claim 34, wherein said report provides said individuals associated with said client module with the means to provide feedback for each line item, said feedback being stored within a database accessible by said individuals associated with said research entity using said research and clearance module.

52. The interactive system of claim 51, wherein said interactive system automatically time stamps comments entered by said individuals associated with said client module.

53. The interactive system of claim 51, wherein said report provides said individuals associated with said client module with the means to associate electronic documents for each line item, said electronic documents being stored within a database accessible by said individuals associated with said research entity using said research and clearance module.

54. A method for conducting a research project comprising the steps of:
providing a computer based interactive system comprising:
a platform administrator module;
a research and clearance module;
a client module;
a database suitable for storing data entered through said platform administrator module, said research and clearance module and said client module;
a platform administrator accessing said interactive system using said platform administrator module; said platform administrator adding a project to said system;
said platform administrator adding a research entity to said system;
said platform administrator adding a client entity to said system.

55. The method of claim 54, wherein said platform administrator accesses said interactive system through said platform administrator module using a web browser.

56. The method of claim 55, further comprising the steps of:
associating at least one individual with said research entity; associating at least one individual with said client entity; and, setting the access rights to said interactive system for each individual.

57. The method of claim 56, further comprising the step of:
at least one individual associated with said research entity accessing the interactive system through said research and clearance module.

58. The method of claim 57, further comprising the step of said individual associating at least one additional individual with said research entity and setting access rights to said interactive system through said research and clearance module for said additional individual.

59. The method of claim 56, further comprising the step of:
at least one individual associated with said client entity accessing the interactive system through said client module.

60. The method of claim 59, further comprising the step of:
said individual accessing said interactive system and associating at least one additional individual with said client entity and setting access rights to said interactive system through said client module for said additional individual.

61. The method of claim 54, wherein said step of adding a project comprises:
said platform administrator accessing said interactive system through said platform administrator module using a web browser and selecting a link or tab associated with a data entry web page; and
entering data related to said project on said data entry web page.

62. The method of claim 61, wherein said platform administrator associates a client entity with said project or adds a new client entity to said interactive system and associates said new client entity with said project.

63. The method of claim 61, wherein said platform administrator associates a research entity with said project or adds a new research entity to said interactive system and associates said new research entity with said project.

64. The method of claim 55, further comprising the step of said platform administrator accessing said platform administrator module, viewing a platform administrator homepage and selecting a link providing access to a webpage view depicting current client entities, current projects and research entities associated with said projects.

65. The method of claim 64, wherein said platform administrator toggles between views of currently active client entities, inactive client entities and all client entities stored in said interactive system.

66. The method of claim 57, further comprising the step of an individual associated with said research entity accessing said interactive system via said research and clearance module and viewing those projects associated with said research entity.

67. The method of claim 66, further comprising the step of an individual associated with said research entity establishing a report using a template provided by said research and clearance module.

68. The method of claim 67, further comprising the step of adding data to said report using said template provided by said research and clearance module wherein said data includes the name of an item and the research status of said item.

69. The method of claim 68, further comprising the step of adding at least one electronic file, relating to at least one item in said report, to a database associated with said report.

70. The method of claim 68, wherein said step of adding data comprises the steps of:
accessing a webpage suitable for entering an item's name;
identifying a category for said item; and,
entering text commentary to be associated with said item.

71. The method of claim 68, further comprising the step of at least one individual associated with said research entity accessing data relating to at least one individual associated with said client entity and using said data to notify said individual associated with said client entity of a report on said interactive system associated with said client entity's project.

72. The method of claim 59, further comprising the step of an individual associated with said client entity accessing said interactive system via said client module and viewing those projects associated with said client entity.

73. The method of claim 72, further comprising the steps of reviewing at least one report associated with a project and adding data to said report using said client module.

74. The method of claim 72, further comprising the step of adding at least one electronic file, relating to an item in a report associated with said project, to a database associated with said report.

75. The method of claim 73, wherein said step of adding data comprises the steps of:
accessing a webpage suitable for reviewing a report associated with said project; reviewing said report;
selecting an item from said report and accessing a webpage associated with said item; and,
using said webpage associated with said item to enter data relating to said item.

76. The method of claim 73, wherein said data associated with said item is selected from the group consisting of text comments and electronic files.

77. The method of claim 75, further comprising the step of at least one individual associated with said client entity accessing data relating to at least one individual associated with said research entity and using said data to notify said individual associated with said research entity of the addition of comments to said report on said interactive system.

78. The method of claim 77, further comprising the step of at least one individual associated with said research entity receiving a notice from at least one individual from said client entity concerning the addition of data to said report and said individual associated with said research entity accessing said research and clearance module to review and respond to said data.

79. The method of claim 77, wherein said individual associated with said research entity accesses said data using a recent activity link on said research and clearance module to view a webpage of recent activity on said report.
